(19) United States
(12) Patent Application Publication
(10) Pub. No.: US 2023/0037064 A1
(43) Pub. Date: Feb. 2, 2023

(54) PROTON TRANSPORT MEMBRANES AND METHODS OF MAKING AND USE THEREOF

(71) Applicant: Vanderbilt University, Nashville, TN (US)

(72) Inventors: Piran Ravichandran Kidambi, Nashville, TN (US); Sokrates T. Pantelides, Nashville, TN (US); Andrew O'Hara, Nashville, TN (US); Deliang Bao, Nashville, TN (US); Nicole Moehring, Nashville, TN (US)

(21) Appl. No.: 17/780,782

(22) PCT Filed: Nov. 25, 2020
(86) PCT No.: PCT/US2020/062133

§ 371 Date: May 27, 2022

Related U.S. Application Data
(60) Provisional application No. 62/941,102, filed on Nov. 27, 2019.

(51) Int. Cl. H01M 8/1041; H01M 8/103; H01M 8/1032

(52) U.S. Cl. CPC H01M 8/1041; H01M 8/103; H01M 8/1032

(57) ABSTRACT

Disclosed herein are proton transport membranes and methods of making and use thereof. The proton transport membranes comprise: a two-dimensional (2D) material having a top surface and a bottom surface; wherein the two-dimensional material comprises graphene and hexagonal-boron nitride in an atomic ratio of from 100:0 to 0:100. In some examples: the top surface is functionalized with a first functional moiety and the bottom surface is not functionalized; the top surface is functionalized with a first functional moiety and the bottom surface is functionalized with the first functional moiety; or the top surface is functionalized with a first functional moiety and the bottom surface is functionalized with a second functional moiety, the second functional moiety being different than the first functional moiety. In some examples, the two-dimensional material is doped with a substitutional dopant in an amount of from greater than 0 atomic % (at %) to less than 100 at %.

### CROSS-REFERENCE TO RELATED APPLICATIONS

This application claims the benefit of priority to U.S. Provisional Application No. 62/941,102 filed Nov. 27, 2019, which is hereby incorporated herein by reference in its entirety.

### BACKGROUND

Membrane technologies present potential for alleviating global problems in energy that directly impact the lives of billions of people around the world. Disruptive technologies such as selective transport of protons through an atomically thin 2D material lattice can play a critical role in advancing next-generation fuel cells, hydrogen purification, isotope separation, environmental remediation, and other applications. Such advances can contribute to cleaner energy generation and improved efficiency in energy conversion to help address the causes and detrimental effects of climate change. Realizing such technological advances however hinges on the ability to precisely understand and deliberately manipulate proton transport through the 2D lattice. A fundamental understanding of the mechanisms governing proton transport though the 2D material lattice remains elusive and severely limits progress towards applications. The compositions, devices, and methods described herein address these and other needs.

### SUMMARY

In accordance with the purposes of the disclosed compositions, devices, and methods, as embodied and broadly described herein, the disclosed subject matter relates to proton transport membranes and methods of making and use thereof.

Disclosed herein are proton transport membranes comprising: a two-dimensional (2D) material having a top surface and a bottom surface; wherein the two-dimensional material comprises hexagonal boron nitride, graphene, or a combination thereof; and wherein: the top surface is functionalized with a first functional moiety and the bottom surface is not functionalized; the top surface is functionalized with a first functional moiety and the bottom surface is functionalized with the first functional moiety; or the top surface is functionalized with a first functional moiety and the bottom surface is functionalized with a second functional moiety, the second functional moiety being different than the first functional moiety.

In some examples, the top surface is functionalized with the first functional moiety and the bottom surface is not functionalized. In some examples, the top surface and the bottom surface are functionalized with the first functional moiety. In some examples, the first functional moiety is selected from the group consisting of hydrogen, halogen, and combinations thereof. In some examples, the first functional moiety comprises hydrogen. In some examples, the first functional moiety comprises F, Cl, Br, I, or a combination thereof. In some examples, the first functional moiety comprises F, Cl, or a combination thereof. In some examples, the first functional moiety comprises H, F, Cl, or a combination thereof. In some examples, first functional moiety comprises H, F, or a combination thereof.

In some examples, the top surface is functionalized with the first functional moiety and the bottom surface is functionalized with the second functional moiety, the second functional moiety being different than the first functional moiety. In some examples, the two-dimensional material comprises graphene such that the membrane comprises Janus graphene. In some examples, the first functional moiety and the second functional moiety are selected from the group consisting of H, F, Cl, Br, I, and combinations thereof. In some examples, the first functional moiety comprises H. In some examples, the second functional moiety comprises F, Cl, Br, I, or a combination thereof. In some examples, the second functional moiety comprises F, Cl, or a combination thereof. In some examples, the first functional moiety comprises H and the second functional moiety comprises F or Cl. In some examples, the first functional moiety comprises H and the second functional moiety comprises F. In some examples, the two-dimensional material comprises graphene and the first functional moiety, the second functional moiety, or a combination thereof comprise(s) H, F, Cl, or a combination thereof.

In some examples, the two-dimensional material is doped with a substitutional dopant in an amount of from greater than 0 atomic % (at %) to less than 100 at %, from greater than 0 at % to 50 at %, or from greater than 0% to 9 at %.

Also disclosed herein are proton transport membranes comprising: a two-dimensional (2D) material having a top surface and a bottom surface; wherein the two-dimensional material comprises hexagonal boron nitride, graphene, or a combination thereof; and wherein the two-dimensional material is doped with a substitutional dopant in an amount of from greater than 0 atomic % (at %) to less than 100 at %. In some examples, the two-dimensional material is doped with a substitutional dopant in an amount of from greater than 0 at % to 50 at %, or from greater than 0% to 9 at %.

In some examples, the substitutional dopant comprises a group I-VII element atom, a period I-VII, or a combination thereof. In some examples, the substitutional dopant comprises a light element atom, a heavy element atom, or a combination thereof. In some examples, the substitutional dopant comprises a metal atom, a metalloid atom, a non-metal atom, or a combination thereof. In some examples, the substitutional dopant comprises a non-metal atom and the non-metal atom comprises a halogen atom. In some examples, the two-dimensional material comprises graphene and the substitutional dopant comprises B, N, P, S, Ge, Sn, Se, Te, Fe, Si, Cu, As, Sb, Bi, or a combination thereof. In some examples, the two-dimensional material comprises graphene and the substitutional dopant comprises B, N, P, S, or a combination thereof. In some examples, the two-dimensional material comprises graphene and the substitutional dopant comprises S. In some examples, the two-dimensional material comprises h-BN and the substitutional dopant comprises C.

In some examples, the two-dimensional material comprises graphene and hexagonal-boron nitride in an atomic ratio of from 100:0 to 0:100, from 99:1 to 1:99, from 90:10 to 10:90, from 80:20 to 20:80, from 70:30 to 30:70, or from 60:40 to 40:60.

Also disclosed herein are proton transport membranes comprising: a two-dimensional (2D) material having a top surface and a bottom surface; wherein the two-dimensional material comprises graphene and hexagonal-boron nitride in an atomic ratio of from 100:0 to 0:100. In some examples, the two-dimensional material comprises graphene and hexagonal-boron nitride in an atomic ratio of from 99:1 to 1:99, from 90:10 to 10:90, from 80:20 to 20:80, from 70:30 to 30:70, or from 60:40 to 40:60.

In some examples, the two-dimensional material comprises graphene. In some examples, the graphene comprises monolayer graphene. In some examples, the graphene comprises large single crystal domains substantially free of grain boundaries or a polycrystalline film.

In some examples, the proton transport membrane further comprises a first proton conducting polymer. In some examples, the first proton conducting polymer is deposited on the top surface and/or the bottom surface of the two-dimensional material. In some examples, the proton transport membrane further comprises a second proton conducting polymer, the second proton conducting polymer being different than the first proton conducting polymer. In some examples, the first proton conducting polymer is deposited on the top surface and the second proton conducting polymer is deposited on the bottom surface. In some examples, the first proton conducting polymer, the second proton conducting polymer, or a combination thereof comprise(s) a polyether, a polysulfonate, a polysulfone, a poly(imidazole), a triazole, a benzimidazole, a polyester, a polycarbonate, a polymer derived from a pyridine monomer, a polyethylene, a fluoropolymer, derivatives thereof, or combinations thereof. In some examples, the first proton conducting polymer, the second proton conducting polymer, or a combination thereof comprise(s) a sulfonated fluoropolymer. In some examples, the first proton conducting polymer, the second proton conducting polymer, or a combination thereof comprise(s) a tetrafluoroethylene based polymer or a derivative thereof. In some examples, the first proton conducting polymer, the second proton conducting polymer, or a combination thereof comprise(s) a sulfonated tetrafluoroethylene based polymer. In some examples, the first proton conducting polymer, the proton conducting second polymer, or a combination thereof comprise(s) a copolymer of tetrafluoroethylene and perfluoro-3,6-dioxa-4-methyl-7-octene-sulfonic acid (Nafion), poly(tetrafluoroethylene-co-2,2,4-trifluoro-5-trifluoromethoxy-1,3-dioxole) (Hyflon), derivatives thereof, or combinations thereof.

Also disclosed herein are methods of controlling proton transport through the proton transport membranes described herein, wherein proton transport through the membrane is controlled by: selecting the composition of the two-dimensional material; functionalizing the top surface and/or the bottom surface of the two-dimensional material; doping the two-dimensional material; the presence and/or composition of the first proton conducting polymer and/or the second proton conducting polymer; or a combination thereof. In some examples, the method comprises controlling the transport behavior of thermal protons through the proton conducting membrane by manipulating the electronic bonding environment and/or surface charge of the proton conducting membrane. In some examples, controlling the proton transport comprises accelerating the proton transport through the proton transport membrane. In some examples, controlling the proton transport comprises slowing the proton transport through the proton transport membrane.

Also disclosed herein are methods of making the proton transport membranes described herein. In some examples, the two-dimensional material comprises graphene and the method comprises synthesizing the graphene using a chemical vapor deposition (CVD) process. In some examples, the two-dimensional material comprises graphene and the first functional moiety and/or second functional moiety comprise(s) F, and the method comprises exposing the graphene to XeF₂ at 70° C. for 1-40 hours. In some examples, the two-dimensional material comprises graphene and the first functional moiety and/or second functional moiety comprise(s) Cl, and the method comprises photochemical chlorination of graphene. In some examples, the two-dimensional material comprises graphene and the first functional moiety and/or second functional moiety comprise(s) H, and the method comprises exposing the graphene to a cold hydrogen plasma.

Also disclosed herein are proton transport devices comprising the proton transport membranes described herein. In some examples, the proton transport device comprises a Nafion-graphene-Nafion sandwich proton pump device, a Nafion-graphene-Pt proton pump device coupled to a mass spectrometer, a liquid-cell device comprising a suspended graphene membrane, or a combination thereof.

Also disclosed herein are methods of use of the proton transport membranes and/or the proton transport devices described herein, the methods comprising using the proton transport membrane or proton transport device in a fuel cell, in a gas purification, in an energy conversion process, in environmental remediation, in isotope separation, in a membrane electrode application, or a combination thereof. In some examples, the gas purification comprises hydrogen gas purification.

Additional advantages of the disclosed devices and methods will be set forth in part in the description which follows, and in part will be obvious from the description. The advantages of the disclosed devices will be realized and attained by means of the elements and combinations particularly pointed out in the appended claims. It is to be understood that both the foregoing general description and the following detailed description are exemplary and explanatory only and are not restrictive of the disclosed devices and methods, as claimed.

The details of one or more embodiments of the invention are set forth in the accompanying drawings and the description below. Other features, objects, and advantages of the invention will be apparent from the description and drawings, and from the claims.

### DESCRIPTION OF FIGURES

The accompanying figures, which are incorporated in and constitute a part of this specification, illustrate several aspects of the disclosure, and together with the description, serve to explain the principles of the disclosure.

FIG. 1. Electron density distribution in graphene hexagonal rings. Gaps/pores in the electron density distribution allows for proton transport.

FIG. 2. Electron density distribution in h-BN hexagonal rings through which proton transport occurs. Gaps/pores in the electron density distribution allows for proton transport.

FIG. 3. Janus graphene with each surface functionalized differently.

FIG. 4. Current vs. voltage plots for Nafion-graphene-Nafion sandwich proton pump devices (top inset), indicating proton transport through monolayer graphene and h-BN (Hu et al. Nat. Nanotechnol. 2018, 13, 468-472). Mechanically exfoliated graphene was suspended over a 2 μm diameter aperture in Si wafer (middle inset, sale bar ˜1 μm) and coated it with 5% Nafion solution on both sides before palladium hydride electrodes were attached to allow for electrical pumping of protons by sealing the device between two metal chambers with H₂ gas and liquid water to ensure hydration of Nafion (Hu et al. Nat. Nanotechnol. 2018, 13, 468-472).

FIG. 5. Areal conductivity of protons computed from FIG. 4 (Hu et al. Nat. Nanotechnol. 2018, 13, 468-472).

FIG. 6. Exponential increase in areal conductivity of protons through monolayer graphene and h-BN membranes (for devices shown in FIG. 4) with increasing temperature, indicates the presence of an energy barrier associated with proton transport (Hu et al. Nat. Nanotechnol. 2018, 13, 468-472).

FIG. 7. Areal conductivity of protons through suspended graphene and h-BN membranes measured in liquid phase. Inset shows schematic of the liquid cell set-up where monolayer graphene was suspended over a −2 μm aperture in Si wafer and mounted between side-by-side diffusion cells with 0.1 M HCl solution. Ag/AgCl electrodes on either side were used to measure ionic current as function of applied bias. The graphene edges on the Si wafer are sealed with epoxy (yellow) to prevent leakage (Hu et al. Nat. Nanotechnol. 2018, 13, 468-472).

FIG. 8. Increase in proton conductivity upon coating the 2D material with a discontinuous layer of Pt. Inset shows the schematic of the device with graphene suspended over an aperture (50 μm diameter, bottom inset) in a Si wafer and coated with 1-2 nm Pt on one side and 5% Nafion solution on the other (Hu et al. Nat. Nanotechnol. 2018, 13, 468-472). The devices were contacted with electrodes and sealed between two chambers, one with H₂ gas and liquid water (Nafion side) and the other (Pt side) to a vacuum chamber connected to a mass spectrometer which measured H₂ flow rate when a negative bias was applied to graphene (Hu et al. Nat. Nanotechnol. 2018, 13, 468-472). The current (I) is related to the H₂ flow rate as F=k_{B}T(I/2e) (Hu et al. Nat. Nanotechnol. 2018, 13, 468-472).

FIG. 9. Proton transport through graphene is strongly enhanced upon illumination with visible light in Nafion-graphene-Pt devices similar to inset in FIG. 8 (Lozada-Hidalgo et al. Nat. Nanotechnol. 2018, 13, 300-303).

FIG. 10. Current density vs potential for protons. Inset shows schematic of Nafion-graphene-Nafion membrane-electrode assembly (MEA) with graphite electrodes (Bukola et al. J. Am. Chem. Soc. 2018, 140, 1743-1752). Monolayer CVD graphene ˜2 cm×2 cm was sandwiched between 25 μm thick Nafion layers via hot pressing and graphite electrodes were added on either side of the assembly (Bukola et al. J. Am. Chem. Soc. 2018, 140, 1743-1752).

FIG. 11. Current density vs potential for deuterons indicates resistance to deuteron transport compared to graphene (Bukola et al. J. Am. Chem. Soc. 2018, 140, 1743-1752).

FIG. 12. The introduction of porous filter papers wetted with electrolyte HCl between the Nafion (modified by appropriate cation exchange) and the electrode (Ag/AgCl) allows for probing proton transport (Bukola et al. J. Am. Chem. Soc. 2018, 140, 1743-1752).

FIG. 13. The introduction of porous filter papers wetted with electrolyte KCl between the Nafion (modified by appropriate cation exchange) and the electrode (Ag/AgCl) allows for probing potassium ion transport along with direct comparison to proton transport (FIG. 12) (Bukola et al. J. Am. Chem. Soc. 2018, 140, 1743-1752). Negligible transport of potassium ion is observed for these devices indicating the observed proton conductance is not from defects in CVD graphene.

FIG. 14. Hydrogenation facilitates proton transport through the graphene lattice by lowering the energy barrier from >3 eV to <1 eV (Feng et al. J. Phys. Chem. Lett. 2017, 8, 6009-6014).

FIG. 15. In-situ observations during graphene growth on Cu offer detailed fundamental in-sights into growth mechanism to tune material quality (Kidambi et al. Nano Lett. 2013, 13, 4769-4778).

FIG. 16. Centimeter-scale atomically thin graphene membranes supported on polycarbonate track etched supports showing less than 2% mass transport for He (Kidambi et al. Nanoscale 2017, 9, 8496-8507).

FIG. 17. Scalable manufacturing processes for atomically thin membranes via roll-to-roll graphene synthesis and facile polymer support casting (Kidambi et al. ACS Appl. Mater. Interfaces 2018, 10, 10369-10378).

FIG. 18. Large single crystalline graphene domains on Cu foil (Kidambi et al. J. Phys. Chem. C 2012, 116, 22492-22501; Braeuninger-Weimer et al. Chem. Mater. 2016, 28, 8905-8915).

FIG. 19. Continuous graphene film (identified via wrinkles) on Cu foil (Kidambi et al. J. Phys. Chem. C 2012, 116, 22492-22501).

FIG. 20. Optical image for continuous graphene film transferred to Si wafer with 300 nm SiO₂ (Butt et al. Adv. Opt. Mater. 2013, 1, 869-874; Kidambi et al. J. Phys. Chem. C 2012, 116, 22492-22501).

FIG. 21. Raman spectrum for continuous graphene film transferred to Si wafer with 300 nm SiO₂ confirms high quality monolayer graphene (absence of D peak −1350 cm⁻¹) (Kidambi et al. J. Phys. Chem. C 2012, 116, 22492-22501).

FIG. 22. Schematic of the set-up to measure diffusion-driven flow of KCl across suspended graphene membranes to quantify leakage through defects.

FIG. 23. KCl transport measured for bare polycarbonate track etched (PCTE) membrane with ˜200 nm pores and graphene transferred on PCTE supports to quantify leakage through defects in graphene (Kidambi et al. Adv. Mater. 2017, 29, 1605896).

FIG. 24. Hot pressed Nafion 212 (50 μm thick) on CVD graphene on Cu.

FIG. 25. Subsequent etch of Cu foil from the device in FIG. 24 allows for graphene transfer on Nafion.

FIG. 26. Raman spectra confirms graphene transfer on Nafion.

FIG. 27. Current density vs Voltage characteristics for Nafion-graphene devices. Inset show an image of the device with electrodes.

FIG. 28. Schematic of Nafion-graphene-Nafion sandwich device (Hu et al. Nat. Nanotechnol. 2018, 13, 468-472). Mechanically exfoliated graphene was initially suspended over a silicon nitride 300×300 μm² aperture and coated with 5% Nafion solution on both sides before palladium hydride electrodes were mechanically attached to allow for electrical pumping of protons when sealed between two metal chambers with H₂ gas and liquid water (Hu et al. Nat. Nanotechnol. 2018, 13, 468-472).

FIG. 29. Schematic of a graphene suspended over a silicon nitride 300×300 μm² aperture and coated with 1-2 nm Pt on one side and 5% Nafion solution on the other (Lozada-Hidalgo et al. Nat. Nanotechnol. 2018, 13, 300-303). The device was sealed between two chambers one with H₂ gas and liquid water (Nafion side) and the other (Pt side) a vacuum chamber connected to a mass spectrometer (Lozada-Hidalgo et al. Nat. Nanotechnol. 2018, 13, 300-303).

FIG. 30. Schematic of Nafion-graphene-Nafion membrane-electrode assembly (Bukola et al. J. Am. Chem. Soc. 2018, 140, 1743-1752). Monolayer of CVD graphene was sandwiched between 25 μm thick Nafion layers via hot pressing and carbon cloth was added as an electrode on either side of the assembly (Bukola et al. J. Am. Chem. Soc. 2018, 140, 1743-1752).

FIG. 31. Electron density distribution in S-doped graphene. A sulfur atom replacing two C atoms leads to much larger hexagonal rings that are predicted to enhance proton transport.

FIG. 32. DOS of graphene in the presence of a physisorbed H after removing one electron from the supercell.

FIG. 33. Contour-plot side view of the electron density for H in a “Gr+H” supercell and “Gr+H-e” supercell (one electron is removed, presumed to result in a proton), where H is at a physisorbed or p-site (top panels) and at a hexagon center or h-site (lower panels). The electron densities appear identical in both the Gr+h and the Gr+H-e supercells.

FIG. 34. The function Q(R) defined in the text for H atoms in graphene as indicated, showing that removal of an electron from the supercell does not convert H to a proton. The results are also compared with the same function for a free H or H in H₂.

FIG. 35. H-transport energy barriers as a function of doping level, calculated by removing or adding fractional electrons (black points). The red triangle indicates a barrier value based on a suitably large supercell from which a whole electron is removed, verifying the accuracy of using fractional electrons.

FIG. 36. H-transport barriers in undoped and doped graphene; labels in quotes indicate doping via fractional electrons as described in the text. IS, TS, and FS stand for initial, intermediate, and final state, respectively.

FIG. 37. H-transport barriers in S-doped graphene for both the next-to-S and far-away hexagons.

FIG. 38. Optical images of S-doped graphene synthesized via CVD using S dissolved in hexane (Gao et al. Nanotechnology, 2012, 23(27), 275605).

FIG. 39. Raman spectra of S-doped graphene synthesized via CVD using S dissolved in hexane (Gao et al. Nanotechnology, 2012, 23(27), 275605).

FIG. 40. XPS spectra of S-doped graphene synthesized via CVD using S dissolved in hexane (Gao et al. Nanotechnology, 2012, 23(27), 275605).

FIG. 41. TEM image of S-doped graphene synthesized via CVD using S dissolved in hexane (Gao et al. Nanotechnology, 2012, 23(27), 275605).

FIG. 42. Line scan corresponding to FIG. 41 showing S-doping of carbon nanotubes (El-Sawy et al. Adv. Energy Mater. 2016, 6, 1501966).

FIG. 43. EELS spectra showing S-doping of carbon nanotubes (El-Sawy et al. Adv. Energy Mater. 2016, 6, 1501966).

FIG. 44. XPS spectra and TEM image (inset) indicating S-doping of carbon nanotubes synthesized via CVD (Louisia et al. Catal. Commun. 2018, 109, 65-70).

FIG. 45. STEM image showing Si incorporation into the graphene lattice (Zhou et al. Phys. Rev. Lett. 2012, 109, 206803).

FIG. 46. Schematic image of the STEM image of FIG. 45 showing Si incorporation into the graphene lattice (Zhou et al. Phys. Rev. Lett. 2012, 109, 206803).

FIG. 47. Custom built roll-to-roll CVD reactor for S-doped graphene synthesis (Kidambi et al. ACS Appl. Mater. Interfaces 2018, 10, 10369-10378). H₂S diluted with Ar will be introduced along with the growth gases to contact the Cu foil after annealing at temperature.

FIG. 48. Roll-to-roll hot-press lamination of graphene on Nafion 211 or Nafion 212 followed by immersion in NaOH solution leads to facile graphene lift-off from the Cu foil and allows re-use of the Cu foil (Hempel et al. Nanoscale 2018, 10, 5522-5531).

FIG. 49. STM image of sulfur doped graphene annealed in UHV at 340° C. for 1 hour.

FIG. 50. STM image of the sulfur doped graphene from FIG. 49 after further annealing in UHV at 420° C. for 1 hour.

FIG. 51. STM image of sulfur doped graphene from FIG. 50 after further annealing in UHV at 420° C. for 1 hour. A large bubble is visible in the upper left corner of the image.

FIG. 52. The STM image shown in FIG. 49 with three bright regions indicated with boxes.

FIG. 53. A higher magnification STM image of the left-most bright region from FIG. 52.

FIG. 54. A higher magnification STM image of the center bright region from FIG. 52.

FIG. 55. A higher magnification STM image of the right-most bright region from FIG. 52.

FIG. 56. STM image of sulfur doped graphene.

FIG. 57. Higher magnification STM image of the indicated portion of FIG. 56.

FIG. 58. Line scan of indicated line in FIG. 57.

FIG. 59. XPS spectrum of an S-doped graphene sample that had previously been annealed for STM measurements.

FIG. 60. XPS spectra of S-doped graphene as a function of annealing in vacuum.

FIG. 61. Raman spectrum of S doped graphene showing an increase in the D peak, indicating defects in the lattice.

### DETAILED DESCRIPTION

The compositions, devices, and methods described herein may be understood more readily by reference to the following detailed description of specific aspects of the disclosed subject matter and the Examples included therein.

Before the present compositions, devices, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “the compound” includes mixtures of two or more such compounds, reference to “an agent” includes mixture of two or more such agents, and the like.

“Optional” or “optionally” means that the subsequently described event or circumstance can or cannot occur, and that the description includes instances where the event or circumstance occurs and instances where it does not.

As used herein, by a “subject” is meant an individual. Thus, the “subject” can include domesticated animals (e.g., cats, dogs, etc.), livestock (e.g., cattle, horses, pigs, sheep, goats, etc.), laboratory animals (e.g., mouse, rabbit, rat, guinea pig, etc.), and birds. “Subject” can also include a mammal, such as a primate or a human.

It is understood that throughout this specification the identifiers “first” and “second” are used solely to aid the reader in distinguishing the various components, features, or steps of the disclosed subject matter. The identifiers “first” and “second” are not intended to imply any particular order, amount, preference, or importance to the components or steps modified by these terms.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

Disclosed herein are proton transport membranes and methods of making and use thereof. The proton transport membranes disclosed herein can transport protons, wherein “proton” as used herein includes ¹H⁺, ²H⁺ (deuteron), ³H⁺ (triton), and combinations thereof.

For example, disclosed herein are proton transport membranes comprising a two-dimensional (2D) material having a top surface and a bottom surface; wherein the two-dimensional material comprises hexagonal boron nitride, graphene, or a combination thereof; and wherein: the top surface is functionalized with a first functional moiety and the bottom surface is not functionalized; the top surface is functionalized with a first functional moiety and the bottom surface is functionalized with the first functional moiety; or the top surface is functionalized with a first functional moiety and the bottom surface is functionalized with a second functional moiety, the second functional moiety being different than the first functional moiety. The first functional moiety, the second functional moiety, or a combination thereof can, for example, be selected from the group consisting of H, F, Cl, Br, I, and combinations thereof.

In some examples, the top surface is functionalized with the first functional moiety and the bottom surface is not functionalized. In some examples, the top surface and the bottom surface are functionalized with the first functional moiety. The first functional moiety can, for example, be selected from the group consisting of hydrogen, halogen, and combinations thereof. In some examples, the first functional moiety comprises hydrogen. In some examples, the first functional moiety comprises F, Cl, Br, I, or a combination thereof. In some examples, the first functional moiety comprises F, Cl, or a combination thereof. In some examples, the first functional moiety comprises H, F, Cl, or a combination thereof. In some examples, the first functional moiety comprises H, F, or a combination thereof.

In some examples, the top surface is functionalized with the first functional moiety and the bottom surface is functionalized with the second functional moiety, the second functional moiety being different than the first functional moiety. In some examples, the two-dimensional material comprises graphene such that the membrane comprises Janus graphene. In some examples, the first functional moiety and the second functional moiety are selected from the group consisting of H, F, Cl, Br, I, and combinations thereof. In some examples, the first functional moiety comprises H. In some examples, the second functional moiety comprises F, Cl, Br, I, or a combination thereof. In some examples, the second functional moiety comprises F, Cl, or a combination thereof. In some examples, the first functional moiety comprises H and the second functional moiety comprises F or Cl. In some examples, the first functional moiety comprises H and the second functional moiety comprises F.

In some examples, the two-dimensional material comprises graphene and the first functional moiety, the second functional moiety, or a combination thereof comprise(s) H, F, Cl, or a combination thereof. In some examples, the two-dimensional material can comprise graphene functionalized to form fluorographene, graphane, or Janus graphene.

The two-dimensional material can, in some examples, be doped with a substitutional dopant in an amount of greater than 0 atomic % (at %) or more (e.g., 0.5 at % or more, 1 at % or more, 1.5 at % or more, 2 at % or more, 2.5 at % or more, 3 at % or more, 3.5 at % or more, 4 at % or more, 4.5 at % or more, 5 at % or more, 5.5 at % or more, 6 at % or more, 6.5 at % or more, 7 at % or more, 7.5 at % or more, 8 at % or more, 8.5 at % or more, 9 at % or more, 9.5 at % or more, 10 at % or more, 11 at % or more, 12 at % or more, 13 at % or more, 14 at % or more, 15 at % or more, 16 at % or more, 17 at % or more, 18 at % or more, 19 at % or more, 20 at % or more, 25 at % or more, 30 at % or more, 35 at % or more, 40 at % or more, 45 at % or more, 50 at % or more, 55 at % or more, 60 at % or more, 65 at % or more, 70 at % or more, 75 at % or more, 80 at % or more, 85 at % or more, or 90 at % or more). In some examples, the two-dimensional material can be doped with a substitutional dopant in an amount of less than 100 at % (e.g., 99 at % or less, 95 at % or less, 90 at % or less, 85 at % or less, 80 at % or less, 75 at % or less, 70 at % or less, 65 at % or less, 60 at % or less, 55 at % or less, 50 at % or less, 45 at % or less, 40 at % or less, 35 at % or less, 30 at % or less, 25 at % or less, 20 at % or less, 19 at % or less, 18 at % or less, 17 at % or less, 16 at % or less, 15 at % or less, 14 at % or less, 13 at % or less, 12 at % or less, 11 at % or less, 10 at % or less, 9.5 at % or less, 9 at % or less, 8.5 at % or less, 8 at % or less, 7.5 at % or less, 7 at % or less, 6.5 at % or less, 6 at % or less, 5.5 at % or less, 5 at % or less, 4.5 at % or less, 4 at % or less, 3.5 at % or less, 3 at % or less, 2.5 at % or less, 2 at % or less, 1.5 at % or less, 1 at % or less, or 0.5 at % or less). The amount of substitutional dopant the two-dimensional material is doped with can range from any of the minimum values described above to any of the maximum values described above. For example, the two-dimensional material can be doped with a substitutional dopant in an amount of from greater than 0 at % to less than 100 at % (e.g., from greater than 0 at % to 50 at %, from 50 at % to less than 100 at %, from greater than 0 at % to 25 at %, from 25 at % to 50 at %, from 50 at % to 75 at %, from 75 at % to less than 100 at %, from greater than 0 at % to 10 at %, from 10 at % to 20 at %, from 20 at % to 30 at %, from 30 at % to 40 at %, from 40 at % to 50 at %, from 1 at % to 50 at %, from 50 at % to 99 at %, from 1 at % to 99 at %, from 5 at % to 50 at %, from greater than 0 at % to 40 at %, from 5 at % to 40 at %, from greater than 0% to 90%, from 5% to less than 100 at %, from 5 at % to 90 at %, or from greater than 0 at % to 9 at %).

Also disclosed herein are proton transport membranes comprising: a two-dimensional (2D) material having a top surface and a bottom surface; wherein the two-dimensional material comprises hexagonal boron nitride, graphene, or a combination thereof; wherein the two-dimensional material is doped with a substitutional dopant in an amount of from greater than 0 at % to less than 100 at %. The two-dimensional material can, in some examples, be doped with a substitutional dopant in an amount of greater than 0 atomic % (at %) or more (e.g., 0.5 at % or more, 1 at % or more, 1.5 at % or more, 2 at % or more, 2.5 at % or more, 3 at % or more, 3.5 at % or more, 4 at % or more, 4.5 at % or more, 5 at % or more, 5.5 at % or more, 6 at % or more, 6.5 at % or more, 7 at % or more, 7.5 at % or more, 8 at % or more, 8.5 at % or more, 9 at % or more, 9.5 at % or more, 10 at % or more, 11 at % or more, 12 at % or more, 13 at % or more, 14 at % or more, 15 at % or more, 16 at % or more, 17 at % or more, 18 at % or more, 19 at % or more, 20 at % or more, 25 at % or more, 30 at % or more, 35 at % or more, 40 at % or more, 45 at % or more, 50 at % or more, 55 at % or more, 60 at % or more, 65 at % or more, 70 at % or more, 75 at % or more, 80 at % or more, 85 at % or more, or 90 at % or more). In some examples, the two-dimensional material can be doped with a substitutional dopant in an amount of less than 100 at % (e.g., 99 at % or less, 95 at % or less, 90 at % or less, 85 at % or less, 80 at % or less, 75 at % or less, 70 at % or less, 65 at % or less, 60 at % or less, 55 at % or less, 50 at % or less, 45 at % or less, 40 at % or less, 35 at % or less, 30 at % or less, 25 at % or less, 20 at % or less, 19 at % or less, 18 at % or less, 17 at % or less, 16 at % or less, 15 at % or less, 14 at % or less, 13 at % or less, 12 at % or less, 11 at % or less, 10 at % or less, 9.5 at % or less, 9 at % or less, 8.5 at % or less, 8 at % or less, 7.5 at % or less, 7 at % or less, 6.5 at % or less, 6 at % or less, 5.5 at % or less, 5 at % or less, 4.5 at % or less, 4 at % or less, 3.5 at % or less, 3 at % or less, 2.5 at % or less, 2 at % or less, 1.5 at % or less, 1 at % or less, or 0.5 at % or less). The amount of substitutional dopant the two-dimensional material is doped with can range from any of the minimum values described above to any of the maximum values described above. For example, the two-dimensional material can be doped with a substitutional dopant in an amount of from greater than 0 at % to less than 100 at % (e.g., from greater than 0 at % to 50 at %, from 50 at % to less than 100 at %, from greater than 0 at % to 25 at %, from 25 at % to 50 at %, from 50 at % to 75 at %, from 75 at % to less than 100 at %, from greater than 0 at % to 10 at %, from 10 at % to 20 at %, from 20 at % to 30 at %, from 30 at % to 40 at %, from 40 at % to 50 at %, from 1 at % to 50 at %, from 50 at % to 99 at %, from 1 at % to 99 at %, from 5 at % to 50 at %, from greater than 0 at % to 40 at %, from 5 at % to 40 at %, from greater than 0% to 90%, from 5% to less than 100 at %, from 5 at % to 90 at %, or from greater than 0 at % to 9 at %).

The substitutional dopant can comprise a group I-VII element atom, a period I-VII element atom, or a combination thereof. In some examples, the substitutional dopant can comprise a light element atom, a heavy element atom, or a combination thereof. In some examples, the substitutional dopant can comprise a metal atom, a metalloid atom, a non-metal atom (e.g., a halogen atom), or a combination thereof.

In some examples, the two-dimensional material comprises graphene and the substitutional dopant comprises B, N, P, S, Ge, Sn, Se, Te, Pt, Fe, Si, Ni, Cu, As, Sb, Bi, or a combination thereof. In some examples, the two-dimensional material comprises graphene and the substitutional dopant comprises B, N, P, S, Ge, Sn, Se, Te, Fe, Si, Cu, As, Sb, Bi, or a combination thereof. In some examples, the two-dimensional material comprises graphene and the substitutional dopant comprises B, N, P, S, or a combination thereof. In some examples, the two-dimensional material comprises graphene and the substitutional dopant comprises S. In some examples, the two-dimensional material comprises h-BN and the substitutional dopant comprises C.

The two-dimensional material can, for example, comprise graphene and hexagonal-boron nitride in an atomic ratio of 100:0 or less (e.g., 99:1 or less, 95:5 or less, 90:10 or less, 85:15 or less, 80:20 or less, 75:25 or less, 70:30 or less, 65:35 or less, 60:40 or less, 55:45 or less, 50:50 or less, 45:55 or less, 40:60 or less, 35:65 or less, 30:70 or less, 25:75 or less, 20:80 or less, 15:85 or less, 10:90 or less, or 5:95 or less). As used herein, an atomic ratio of 100:0 graphene:hexagonal-boron nitride indicates the two-dimensional material comprises 100 at % graphene and 0 at % hexagonal boron nitride. In some examples, the two-dimensional material can comprise graphene and hexagonal-boron nitride in an atomic ratio of 0:100 or more (e.g., 1:99 or more, 5:95 or more, 10:90 or more, 15:85 or more, 20:80 or more, 25:75 or more, 30:70 or more, 35:65 or more, 40:60 or more, 45:55 or more, 50:50 or more, 55:45 or more, 60:40 or more, 65:35 or more, 70:30 or more, 75:25 or more, 80:20 or more, 85:15 or more, 90:10 or more, or 95:5 or more). The atomic ratio of graphene to hexagonal-boron nitride of the two-dimensional material can range from any of the minimum values described above to any of the maximum values described above. For example, the two-dimensional material can comprise graphene and hexagonal-boron nitride in an atomic ratio of from 100:0 to 0:100 (e.g., from 100:0 to 50:50, from 50:50 to 0:100, from 100:0 to 80:20, from 80:20 to 60:40, from 60:40 to 40:60, from 40:60 to 20:80, from 20:80 to 0:100, from 100:0 to 20:80, from 80:20 to 0:100, from 99:1 to 1:99, from 90:10 to 10:90, from 80:20 to 20:80, from 70:30 to 30:70, or from 55:45 to 45:55).

Also disclosed herein are proton transport membranes comprising: a two-dimensional (2D) material having a top surface and a bottom surface; wherein the two-dimensional material comprises graphene and hexagonal-boron nitride in an atomic ratio of from 100:0 to 0:100. The two-dimensional material can, for example, comprise graphene and hexagonal-boron nitride in an atomic ratio of 100:0 or less (e.g., 99:1 or less, 95:5 or less, 90:10 or less, 85:15 or less, 80:20 or less, 75:25 or less, 70:30 or less, 65:35 or less, 60:40 or less, 55:45 or less, 50:50 or less, 45:55 or less, 40:60 or less, 35:65 or less, 30:70 or less, 25:75 or less, 20:80 or less, 15:85 or less, 10:90 or less, or 5:95 or less). In some examples, the two-dimensional material can comprise graphene and hexagonal-boron nitride in an atomic ratio of 0:100 or more (e.g., 1:99 or more, 5:95 or more, 10:90 or more, 15:85 or more, 20:80 or more, 25:75 or more, 30:70 or more, 35:65 or more, 40:60 or more, 45:55 or more, 50:50 or more, 55:45 or more, 60:40 or more, 65:35 or more, 70:30 or more, 75:25 or more, 80:20 or more, 85:15 or more, 90:10 or more, or 95:5 or more). The atomic ratio of graphene to hexagonal-boron nitride of the two-dimensional material can range from any of the minimum values described above to any of the maximum values described above. For example, the two-dimensional material can comprise graphene and hexagonal-boron nitride in an atomic ratio of from 100:0 to 0:100 (e.g., from 100:0 to 50:50, from 50:50 to 0:100, from 100:0 to 80:20, from 80:20 to 60:40, from 60:40 to 40:60, from 40:60 to 20:80, from 20:80 to 0:100, from 100:0 to 20:80, from 80:20 to 0:100, from 99:1 to 1:99, from 90:10 to 10:90, from 80:20 to 20:80, from 70:30 to 30:70, or from 55:45 to 45:55).

In some examples, the two-dimensional material can comprise graphene, h-BN, or a combination thereof, wherein the graphene and/or h-BN can comprise monolayers or bilayers with ordered AB, AA etc. or turbostratic/random stacking.

In some examples, the two-dimensional material can comprise graphene wherein the graphene comprises monolayer graphene. In some examples, the two-dimensional material can comprise graphene, and the graphene can comprise large single crystal domains substantially free of grain boundaries or a polycrystalline film.

The proton transport membranes can, in some examples, further comprise a first proton conducting polymer. For example, the first proton conducting polymer can be deposited on the top surface and/or the bottom surface of the two-dimensional material. In some examples, the proton transport membranes can further comprise a second proton conducting polymer, the second proton conducting polymer being different than the first proton conducting polymer. For example, the first proton conducting polymer can be deposited on the top surface and the second proton conducting polymer can be deposited on the bottom surface.

The first proton conducting polymer and/or the second proton conducting polymer can, for example, comprise a polymer electrolyte, such as those known in the art. For example, the first proton conducting polymer and/or the second proton conducting polymer can comprise any polymer comprising one or more basic functional groups (e.g., ether, pyridine, sulfonate, etc.). In some examples, the first proton conducting polymer, the second proton conducting polymer, or a combination thereof can comprise a polyether, a polysulfonate, a polysulfone, a poly(imidazole), a triazole, a benzimidazole, a polyester, a polycarbonate, a polymer derived from a pyridine monomer, a polyethylene, a fluoropolymer (e.g., a sulfonated fluoropolymer), derivatives thereof, or combinations thereof. In some examples, the first proton conducting polymer, the second proton conducting polymer, or a combination thereof can comprise a tetrafluoroethylene based polymer or a derivative thereof (e.g., a sulfonated tetrafluoroethylene based polymer). In some examples, the first proton conducting polymer, the proton conducting second polymer, or a combination thereof can comprise a copolymer of tetrafluoroethylene and perfluoro-3,6-dioxa-4-methyl-7-octene-sulfonic acid (Nafion), poly(tetrafluoroethylene-co-2,2,4-trifluoro-5-trifluoromethoxy-1,3-dioxole) (Hyflon), derivatives thereof, or combinations thereof.

In some examples, the two-dimensional material can be free standing. In some examples, the two-dimensional material is supported by a substrate. Examples of suitable substrates include, but are not limited to, polymers (e.g., porous polymers), glass fibers, glass, quartz, silicon, metals, ceramics, nitrides, oxides, porous materials, and combinations thereof.

The composition of the two-dimensional material; functionalization of the top surface and/or the bottom surface of the two-dimensional material; doping of the two-dimensional material; the presence and/or composition of the first proton conducting polymer and/or the second proton conducting polymer; or a combination thereof can be selected in view of a variety of factors. In some examples, the composition of the two-dimensional material; functionalization of the top surface and/or the bottom surface of the two-dimensional material; doping of the two-dimensional material; the presence and/or composition of the first proton conducting polymer and/or the second proton conducting polymer; or a combination thereof can be selected to control proton transport through the proton transport membrane.

Also disclosed herein are methods of controlling proton transport through any of the proton transport membranes disclosed herein, wherein proton transport through the membrane can be controlled by: selecting the composition of the two-dimensional material; functionalizing the top surface and/or the bottom surface of the two-dimensional material; doping the two-dimensional material; the presence and/or composition of the first proton conducting polymer and/or the second proton conducting polymer; or a combination thereof.

In some examples, the methods of controlling proton transport through the proton transport membrane can comprise controlling the transport behavior of thermal protons through the proton conducting membrane by manipulating the electronic bonding environment and/or surface charge of the proton conducting membrane. In some examples, controlling the proton transport can comprise accelerating the proton transport through the proton transport membrane. In some examples, controlling the proton transport comprises slowing the proton transport through the proton transport membrane.

In some examples, described herein are methods of controlling proton transport through a membrane, the membrane comprising a two-dimensional (2D) material having a top surface and a bottom surface, wherein proton transport through the membrane is controlled by functionalizing the top surface and/or the bottom surface, by doping the two-dimensional material, electrostatic pumping inline with applied potential, or a combination thereof. Also described herein are proton transport membranes made by the methods described herein, proton transport devices comprising the proton transport membranes described herein, and methods of use thereof.

For example, the transport behavior of protons can be manipulated (e.g., accelerated or slowed) by changing the bonding environment in the lattice of the two-dimensional material. In some examples, the addition of dopant atoms into the two-dimensional material can control the proton transport through the membrane. For example, the two-dimensional material can comprise graphene where the graphene lattice includes a substitutional dopant such as B, N, P, S etc. In some examples, the two-dimensional material can comprise hexagonal boron nitride (h-BN) wherein the h-BN lattice includes C as a substitutional dopant.

Also disclosed herein are methods of making any of the proton transport membranes described herein. For example, the methods can comprise making the two-dimensional material. In some examples, wherein the two-dimensional material comprises graphene, the methods can comprise synthesizing the graphene using a chemical vapor deposition (CVD) process. In some examples, the methods can comprise functionalizing the top surface and/or the bottom surface of the two-dimensional material. In some examples, wherein the two-dimensional material comprises graphene and the first functional moiety and/or second functional moiety comprise(s) F, the methods can comprise exposing the graphene to XeF₂ at 70° C. for 1-40 hours. In some examples, wherein the two-dimensional material comprises graphene and the first functional moiety and/or second functional moiety comprise(s) Cl, the methods can comprise photochemical chlorination of graphene. In some examples, wherein the two-dimensional material comprises graphene and the first functional moiety and/or second functional moiety comprise(s) H, the methods can comprise exposing the graphene to a cold hydrogen plasma.

Also disclosed herein are proton transport devices comprising any of the proton transport membranes described herein. For example, the proton transport device can comprise a Nafion-graphene-Nafion sandwich proton pump device, a Nafion-graphene-Pt proton pump device coupled to a mass spectrometer, a liquid-cell device comprising a suspended graphene membrane, or a combination thereof.

Also disclosed herein are methods of use of any of the proton transport membranes or proton transport devices described herein. For example, the proton conducting membranes can be used for fuel cells and other proton conducting applications. In some examples, the methods can comprise using the proton transport membrane or proton transport device in a fuel cell, in a gas purification (e.g., hydrogen gas purification), in an energy conversion process, in environmental remediation, in isotope separation, in a membrane electrode application, or a combination thereof. In some examples, the methods can comprise using the proton transport membrane or proton transport device in fuel cells, hydrogen purification, isotope separation, environmental remediation, and/or other applications.

The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1

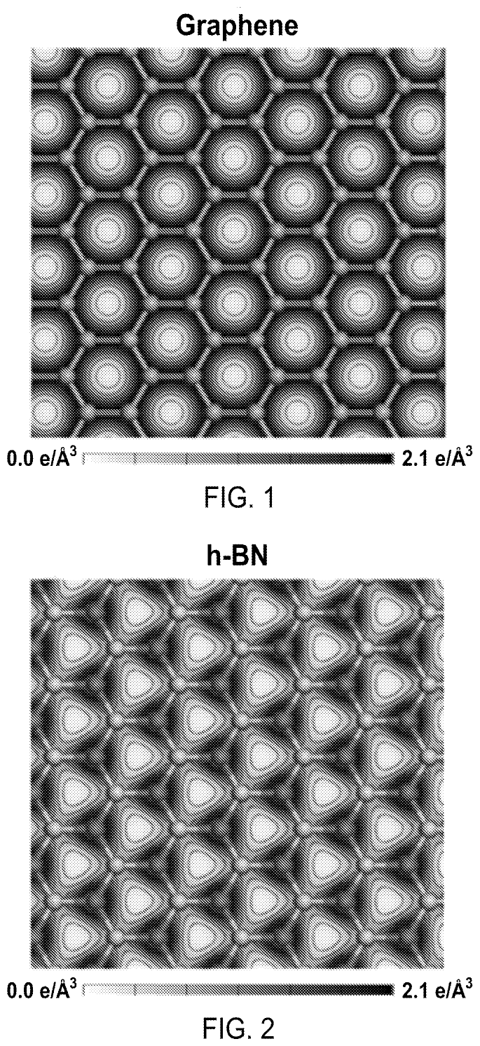

Atomically thin two-dimensional (2D) materials such as graphene and hexagonal boron nitride (h-BN) offer routes to control mass-transport at the sub-nanometer scale by controlled introduction of nanopores (Wang et al. Nat. Nanotechnol. 2017, 12, 509-522; Prozorovska et al. Adv. Mater. 2018, 1801179). Pristine 2D materials, such as monolayer graphene and h-BN, represent the thinnest physical barrier (Wang et al. Nat. Nanotechnol. 2017, 12, 509-522; Prozorovska et al. Adv. Mater. 2018, 1801179). It has been found that, in the absence of defects, monolayer graphene is impermeable to even He atoms, the smallest gas molecule, at room temperature (Bunch et al. Nano Lett. 2008, 8, 2458-2462). Subsequent theoretical calculations found that even H atoms face a prohibitively large energy barrier to penetrate graphene's hexagonal rings (Tsetseris et al. Carbon N. Y. 2014, 67, 58-63; Miao et al. Phys. Chem. Chem. Phys. 2013, 15, 16132), but a significant reduction of the barrier was predicted for protons (Miao et al. Phys. Chem. Chem. Phys. 2013, 15, 16132). Indeed, in 2014, experiments that demonstrated a high rate of proton transport through defect-free monolayer graphene and h-BN were reported (Hu et al. Nature 2014, 516, 227-230; Karnik et al. Nature 2014, 516, 173-175). The transport of protons has been attributed to quantum tunneling due to pores/gaps in the electron density distribution of certain 2D materials. A higher rate of proton transport was observed for h-BN than graphene and was attributed to the somewhat larger pores in the electron density distribution, as seen in FIG. 1 and FIG. 2. Selective proton transport through atomically thin 2D materials presents potential for advancing fuel cell designs, fuel cell membranes (Holmes et al. Adv. Energy Mater. 2017, 7, 1-7), gas purifications such as hydrogen purification (Lozada-Hidalgo et al. Nat. Nanotechnol. 2018, 13, 300-303), energy conversion processes, isotope separation (Hu et al. Nature 2014, 516, 227-230; Hu et al. Nat. Nanotechnol. 2018, 13, 468-472; Bukola et al. J. Am. Chem. Soc. 2018, 140, 1743-1752; Lozada-Hidalgo et al. Science (80-.). 2016, 351, 68-70; Lozada-Hidalgo et al. Nat. Commun. 2017, 8, 15215), environmental remediation (Hu et al. Nature 2014, 516, 227-230; Hu et al. Nat. Nanotechnol. 2018, 13, 468-472; Bukola et al. J. Am. Chem. Soc. 2018, 140, 1743-1752; Lozada-Hidalgo et al. Science (80-.). 2016, 351, 68-70), and membrane electrode applications (Karnik et al. Nature 2014, 516, 173-175). Realizing such technological advances, however, hinges on the ability to: develop an understanding of the transport mechanisms to allow for deliberate and precise control over proton transport through the 2D material lattice; maximize selective proton transport through the 2D lattice; and develop scalable manufacturing processes to synthesize atomically thin membranes in a cost-effective manner with reliable and reproducible quality.

Despite several experimental and theoretical studies, a fundamental and comprehensive understanding of the mechanisms governing proton transport though the 2D material lattice remains elusive and severely limits progress towards applications.

Described herein are methods for experimentally elucidating mechanisms of proton transport through atomically thin membranes, such as atomically thin graphene membranes. Atomistic-simulation-driven and scalable advanced manufacturing processes for atomically thin graphene membranes with high proton flux are further discussed herein.

The methods described herein systematically explore experimental approaches to influence quantum tunneling of thermal protons through atomically thin membranes via changes in the electronic bonding environment on the surface of the atomically thin 2D material. The quantum tunneling behavior of thermal protons can potentially be influenced by manipulating the electronic bonding environment and/or surface charge on monolayer graphene via functionalization. Density Functional Theory (DFT) calculations have indeed suggested that surface functionalization of graphene with hydrogen to form hydrogenated graphene decreases the energy barrier for proton transport from >3 eV to <1 eV but experimental evidence remains elusive (Feng et al. J. Phys. Chem. Lett. 2017, 8, 6009-6014).

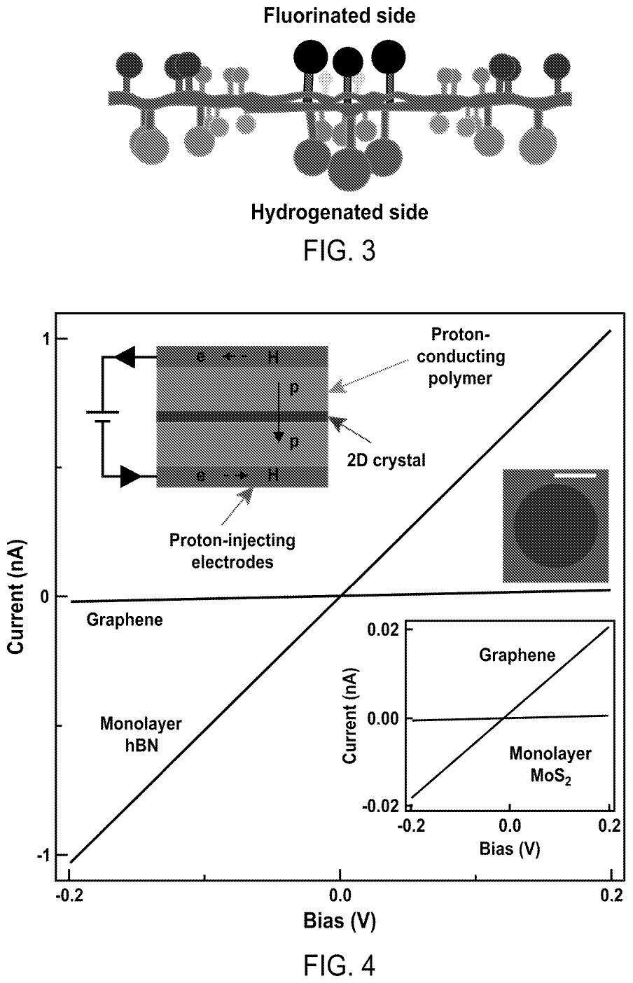

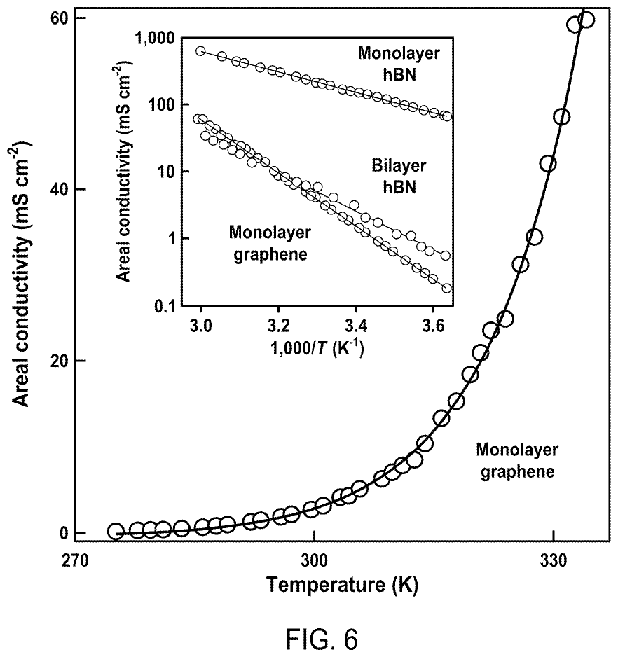

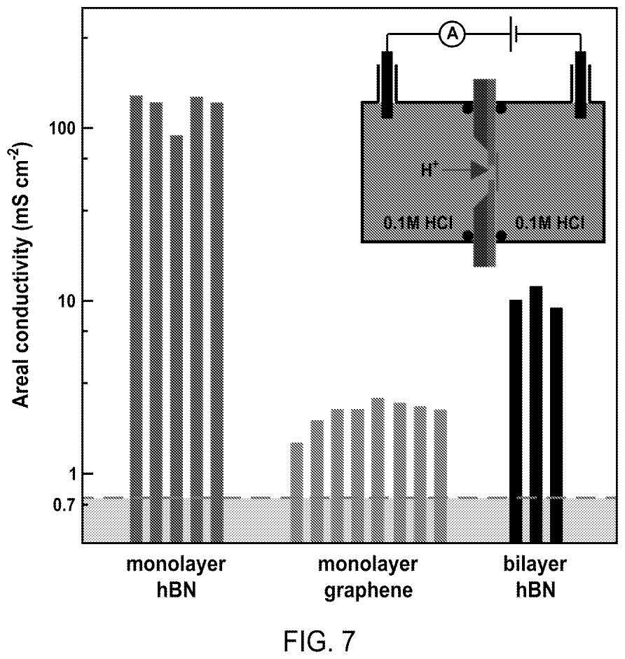

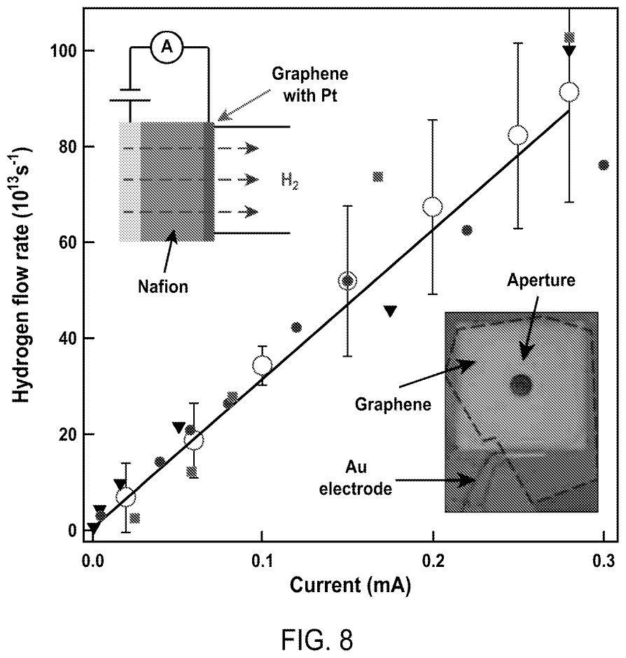

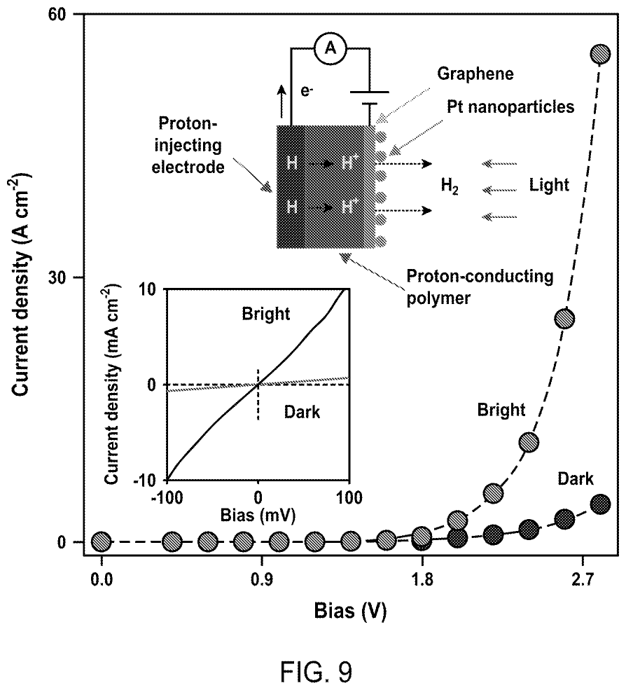

Herein, the influence of surface charge on proton transport through monolayer graphene is systematically explored via selective functionalization of one or both surfaces of the atomically thin graphene lattice with hydrogen or halogens to form hydrogenated graphene (Graphane) or halogenated graphene, respectively. Proton transport is characterized using i) Nafion-graphene-Nafion sandwich proton pump devices (inset in FIG. 4), ii) Nafion-graphene-Pt proton pump devices coupled to a mass spectrometer (inset in FIG. 8 and FIG. 9), and iii) ionic current measurements in a liquid-cell with suspended graphene membranes (inset in FIG. 7). Graphene, hydrogenated graphene, and halogenated graphene represent model systems with positive and negative charges on the graphene surface without significant changes to the structure of the 2D honeycomb lattice, thereby allowing for an effective comparison to probe the influence of surface charge on proton transport. Additionally, proton transport is characterized as a function of temperature for graphene with different functionalization using the Nafion-graphene-Nafion devices to further the understanding of associated energy barriers (FIG. 6). Finally, selective functionalization of only one surface or different functionalization on the two graphene surfaces to form “Janus” graphene is explored (see FIG. 3). Quantum-tunneling-based-accelerated transport of thermal protons via contributions from electrostatic potential effects can be present in Janus graphene.

These methods can lead to insights and information on the influence of surface charge on quantum tunneling of thermal protons through 2D membranes and insights to modulate proton flux across atomically thin membranes, which can be used to predict and control atomic and molecular interactions for chemical separations.

### Background

Here, experimental and theoretical studies on proton transport through atomically thin 2D materials are briefly summarized.

The question of whether graphene is permeable to atoms was first addressed in 2008 by Paul McEwen's group (Bunch et al. Nano Lett. 2008, 8, 2458-2462). They measured permeation rates of micron-scale graphene samples by He and other gases (Bunch et al. Nano Lett. 2008, 8, 2458-2462). They measured negligible leakage rates for micron scale cavities in SiO₂ filled with He gas and capped by monolayer graphene, and thus found that graphene is impermeable to gases (Bunch et al. Nano Lett. 2008, 8, 2458-2462). Their work demonstrated the impermeability of pristine monolayer graphene to the smallest gas molecule (He), making it the thinnest possible physical barrier (Bunch et al. Nano Lett. 2008, 8, 2458-2462). These experiments raised the intriguing question of what happens to species such as protons that are in between electrons that readily tunnel through monolayer graphene (Zhu et al. Nano Lett. 2018, 18, 682-688) or h-BN (Britnell et al. Nano Lett. 2012, 12, 1707-1710), and atoms such as He, which do not transport through the lattice (Bunch et al. Nano Lett. 2008, 8, 2458-2462; Hu et al. Nat. Nanotechnol. 2018, 13, 468-472; Karnik et al. Nature 2014, 516, 173-175).

Later theoretical work found large energy barriers, ˜3-4 eV, for several atomic species, including hydrogen (Tsetseris et al. Carbon N. Y. 2014, 67, 58-63; Miao et al. Phys. Chem. Chem. Phys. 2013, 15, 16132). Theoretical studies for proton transport through the graphene lattice predicted energy barriers −2.86 eV (first principles calculations and harmonic transition state theory) (Miao et al. Phys. Chem. Chem. Phys. 2013, 15, 16132) and −4.2 eV (DFT calculations) (Tsetseris et al. Carbon N. Y. 2014, 67, 58-63). These DFT calculations also predicted a reduction in the energy barrier for proton transport with increasing temperature/annealing (Tsetseris et al. Carbon N. Y. 2014, 67, 58-63). Miao et al. also calculated energy barriers for a proton and found smaller values: 1.4 eV for a perpendicular path through the ring center and 2.2 eV for a path closer to two of the C atoms of the ring where it can form a chemisorbed state (Miao et al. Phys. Chem. Chem. Phys. 2013, 15, 16132).

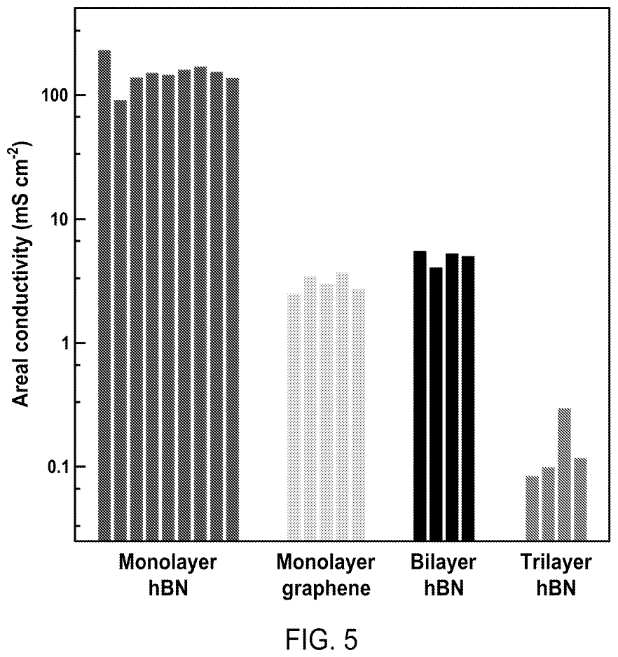

In 2014, Hu et al. reported electric-field-driven transport of protons through a graphene and h-BN monolayer sandwiched between two layers of Nafion, a polymer that selectively conducts protons when hydrated (Hu et al. Nature 2014, 516, 227-230; Karnik et al. Nature 2014, 516, 173-175). Since no other charge carriers were present in the system, the measured current is a direct measure of proton transport (Hu et al. Nature 2014, 516, 227-230; Karnik et al. Nature 2014, 516, 173-175). In a typical experiment, mechanically exfoliated graphene was suspended over a ˜2 μm diameter aperture in a Si wafer (FIG. 4 top and middle inset) and coated with a 5% Nafion solution on both sides (Hu et al. Nature 2014, 516, 227-230). Palladium hydride electrodes were attached to the Nafion and the devices were sealed between two metal chambers with H₂ gas and liquid water to allow for electrical pumping of protons (Hu et al. Nature 2014, 516, 227-230; Karnik et al. Nature 2014, 516, 173-175). The measured areal conductivity of protons for monolayer graphene and h-BN was ˜3 mS cm⁻² and ˜100 mS cm⁻² respectively (FIG. 5). The difference was attributed to larger pores/gaps in the electron density distribution of h-BN compared to graphene (FIG. 1 and FIG. 2) (Hu et al. Nature 2014, 516, 227-230; Karnik et al. Nature 2014, 516, 173-175).

Further, the areal conductivity of protons was found to decrease with an increasing number of layers (Hu et al. Nature 2014, 516, 227-230; Karnik et al. Nature 2014, 516, 173-175). For example, bilayer graphene was found to be almost impermeable to protons, while bilayer h-BN showed reduced conductivity ˜3 mS cm⁻² and trilayer h-BN ˜0.1 mS cm⁻² (FIG. 5) (Hu et al. Nature 2014, 516, 227-230). These differences were attributed to the AB stacking in graphene where a carbon atom in the next layer is located in the center of the hexagonal ring of the 1^{st} layer, while the AA′ stacking in h-BN aligns all hexagonal rings across multiple layers leading to the preservation of the pore in the electron cloud despite an increase in integrated electron density (Hu et al. Nature 2014, 516, 227-230; Karnik et al. Nature 2014, 516, 173-175).

The areal conductivity of protons for monolayer graphene and h-BN was also found to increase exponentially with an Arrhenius dependence on temperature (FIG. 6) (Hu et al. Nature 2014, 516, 227-230; Karnik et al. Nature 2014, 516, 173-175). The resulting activation energies are ˜0.3 eV for h-BN and ˜0.8 eV for graphene (Hu et al. Nature 2014, 516, 227-230; Karnik et al. Nature 2014, 516, 173-175). The observed Arrhenius-type dependence of areal conductivity on temperature (exp(−E/k_{B}T), where T is the temperature and/03 is Boltzmann constant) was consistent with transport mechanisms where protons encounter an energy barrier (h-BN ˜0.3 eV and graphene ˜0.8 eV) while passing through 2D lattice (Hu et al. Nature 2014, 516, 227-230; Karnik et al. Nature 2014, 516, 173-175) in agreement with prior DFT calculations (Tsetseris et al. Carbon N. Y. 2014, 67, 58-63). Notably, graphene showed a higher rate of proton conductivity increase than h-BN (FIG. 6) with increasing temperature (Hu et al. Nature 2014, 516, 227-230; Karnik et al. Nature 2014, 516, 173-175). The Arrhenius behavior indicates that transport at temperatures above 0° C. is dominated by thermal processes as opposed to quantum transport (Hu et al. Nature 2014, 516, 227-230; Karnik et al. Nature 2014, 516, 173-175). The activation energy for graphene, 0.8 eV (Hu et al. Nature 2014, 516, 227-230; Karnik et al. Nature 2014, 516, 173-175), however, is significantly smaller than the theoretical energy-barrier values of 1.4 or 2.2 eV, depending on the path (Miao et al. Phys. Chem. Chem. Phys. 2013, 15, 16132).

Hu et al. also measured areal proton conductivities of ˜3 mS cm⁻² and ˜100 mS cm⁻² for suspended monolayer graphene and h-BN membranes, respectively, in the liquid phase (FIG. 7) (Hu et al. Nat. Nanotechnol. 2018, 13, 468-472). The areal conductivity of protons measured in the liquid state was fully consistent with values obtained from the Nafion-graphene-Nafion devices described earlier (FIG. 4 and FIG. 5) (Hu et al. Nature 2014, 516, 227-230). For liquid phase proton transport measurements, monolayer graphene or h-BN was suspended over a ˜2 μm diameter aperture in Si wafer and mounted between side-by-side diffusion cells with 0.1 M HCl solution (Hu et al. Nature 2014, 516, 227-230). Ag/AgCl electrodes on either side of the membrane measured ionic current as function of applied bias after sealing the graphene edges on the Si wafer with epoxy (yellow in inset of FIG. 7) to prevent leakage (Hu et al. Nature 2014, 516, 227-230). While the liquid-phase measurement set-up allowed for direct measurements of areal conductivity of protons by minimizing any convoluting effects that could arise in Nafion-graphene-Nafion devices, some studies have attributed proton transport in the liquid phase to defects in the graphene lattice (Walker et al. Appl. Phys. Lett. 2015, 107, 213104).

Achtyl et al. also probed liquid-phase proton transport through well-characterized graphene monolayers placed on silica substrates (Achtyl et al. Nat. Commun. 2015, 6, 6539). By cycling the pH of the solution and measuring the corresponding acid-base chemistry of hydroxyl groups on the silica substrate, they ruled out diffusion-driven transport through pin-holes, but found that proton transport occurs through rare, naturally occurring atomic defects in graphene (Achtyl et al. Nat. Commun. 2015, 6, 6539).

Hu et al. showed that the proton conductivity through graphene and h-BN could be increased by more than an order of magnitude by depositing a discontinuous platinum layer on the 2D lattice (FIG. 8) (Hu et al. Nat. Nanotechnol. 2018, 13, 468-472; Karnik et al. Nature 2014, 516, 173-175). In these experiments, the authors suspended graphene on a ˜50 μm diameter aperture in a Si wafer (bottom inset FIG. 8), coated it with 1-2 nm Pt on one side and 5% Nafion solution on the other (Hu et al. Nat. Nanotechnol. 2018, 13, 468-472). The Nafion-graphene-Pt stack was contacted with electrodes on either side and sealed between two chambers, one with H₂ gas and liquid water (Nafion side) and the other (Pt side) a vacuum chamber connected to a mass spectrometer that computed the H₂ flow rate upon the application of a negative bias to graphene (Hu et al. Nat. Nanotechnol. 2018, 13, 468-472). The measured current (I) was related to the H₂ flow rate (F) as F=k_{B}T(I/2e), where T is the temperature (Hu et al. Nat. Nanotechnol. 2018, 13, 468-472). More recently, Lozada-Hidalgo et al. showed exponential increase in proton conductivity upon illuminating the Nafion-graphene-Pt devices shown in FIG. 8 with visible light (FIG. 9) (Lozada-Hidalgo et al. Nat. Nanotechnol. 2018, 13, 300-303).

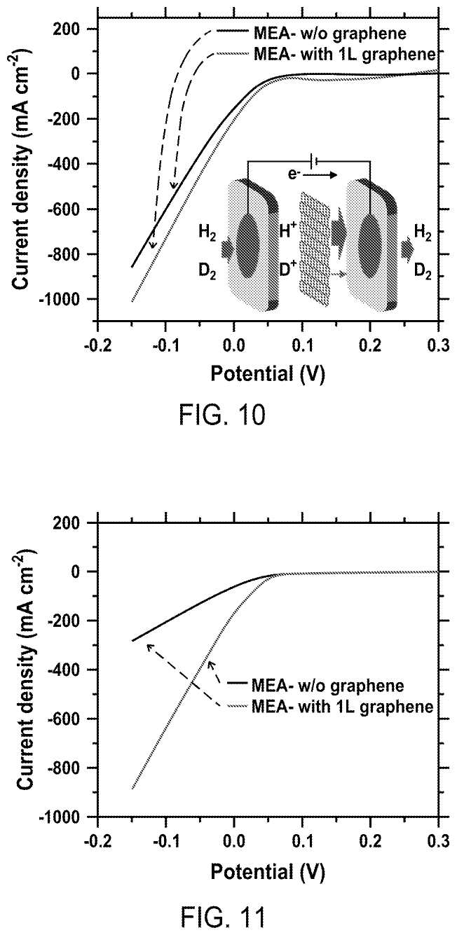

In addition to proton transport, Lozada-Hidalgo et al. also reported hydrogen isotope separation, with a proton-deuteron separation factor ˜10 across monolayer graphene and h-BN membranes using Nafion-graphene-Nafion as well as Nafion-graphene-Pt devices (Lozada-Hidalgo et al. Science (80-.). 2016, 351, 68-70; Lozada-Hidalgo et al. Nat. Commun. 2017, 8, 15215). The separation factor of ˜10 irrespective of the 2D material being tested was attributed to the difference in activation barriers corresponding to the measured ˜60 milli-electron volts (meV) difference between the zero-point energies of incident protons and deuterons (Lozada-Hidalgo et al. Science (80-.). 2016, 351, 68-70; Lozada-Hidalgo et al. Nat. Commun. 2017, 8, 15215). Bukola et al. also measured proton and deuteron transport across graphene using Nafion-graphene-Nafion sandwich devices, i.e. in a polyelectrolyte-membrane (PEM)-style hydrogen pump cell (inset in FIG. 10) by varying the temperature from 30° C. to 60° C. (Bukola et al. Electrochim. Acta 2019, 296, 1-7). The obtained differences in activation energies from Arrhenius plots for protons and (0.50±0.02 eV) and deuterons (0.55±0.05 eV) are in good agreement with the expected differences in vibrational zero-point energies for the O—H and O-D bonds with Nafion (Bukola et al. Electrochim. Acta 2019, 296, 1-7).

Based on the above mentioned experimental and theoretical studies on proton transport through atomically thin 2D materials (including their use in applications for fuel cell membranes (Holmes et al. Adv. Energy Mater. 2017, 7, 1-7) and isotope separation (Karnik et al. Nature 2014, 516, 173-175; Bukola et al. J. Am. Chem. Soc. 2018, 140, 1743-1752; Lozada-Hidalgo et al. Science (80-.). 2016, 351, 68-70; Bukola et al. Electrochim. Acta 2019, 296, 1-7)), the emerging hypothesis on the transport mechanism is that thermal protons tunnel through the hexagonal atomically thin lattice of graphene and h-BN (Hu et al. Nat. Nanotechnol. 2018, 13, 468-472; Holmes et al. Adv. Energy Mater. 2017, 7, 1-7; Bukola et al. J. Am. Chem. Soc. 2018, 140, 1743-1752; Lozada-Hidalgo et al. Science (80-.). 2016, 351, 68-70; Lozada-Hidalgo et al. Nat. Commun. 2017, 8, 15215; Poltaysky et al. J. Chem. Phys. 2018, 148, 204707; Feng et al. J. Phys. Chem. Lett. 2017, 8, 6009-6014). However, literature reports of experimentally measured proton transport through the graphene lattice vary by up to 4 orders of magnitude, indicating the lack of a comprehensive understanding of proton transport through the lattice of 2D materials (Hu et al. Nat. Nanotechnol. 2018, 13, 468-472; Bukola et al. J. Am. Chem. Soc. 2018, 140, 1743-1752).

The value of proton flux initially reported by Hu et al. for mechanically exfoliated graphene sandwiched between two layers of Nafion (FIG. 4) at room temperature, ˜3 mS cm⁻² (Hu et al. Nature 2014, 516, 227-230), is significantly lower than the value ˜12 S cm⁻² for commercially used 50-μm-thick fuel cell membranes (Nafion 212) (Bukola et al. J. Am. Chem. Soc. 2018, 140, 1743-1752). With such low values, ˜3 mS cm⁻², the use of graphene as an atomically thin proton exchange or separation membrane would be impractical in most applications except perhaps isotope separation (Lozada-Hidalgo et al. Science (80-.). 2016, 351, 68-70; Lozada-Hidalgo et al. Nat. Commun. 2017, 8, 15215).

However, Hu et al. showed that the proton conductivity through graphene and h-BN could be increased by elevating temperature to ˜60° C. (˜60 mS cm⁻²) and increased further to ˜90 mS cm⁻² by depositing a discontinuous platinum layer on the 2D lattice (FIG. 8) (Hu et al. Nature 2014, 516, 227-230; Karnik et al. Nature 2014, 516, 173-175). More recently, Lozada-Hidalgo et al. showed an exponential increase in proton conductivity to ˜20 S cm² upon illuminating the Nafion-graphene-Pt devices shown in FIG. 8 with visible light (FIG. 9) (Lozada-Hidalgo et al. Nat. Nanotechnol. 2018, 13, 300-303). These advances have revived interest in graphene as an atomically thin proton separation membrane with a high temperature stability (up to 250-300° C. in air), the ability to operate in dry environments (unlike Nafion), and dual functionality, i.e. membrane and conductive electrode (Karnik et al. Nature 2014, 516, 173-175).

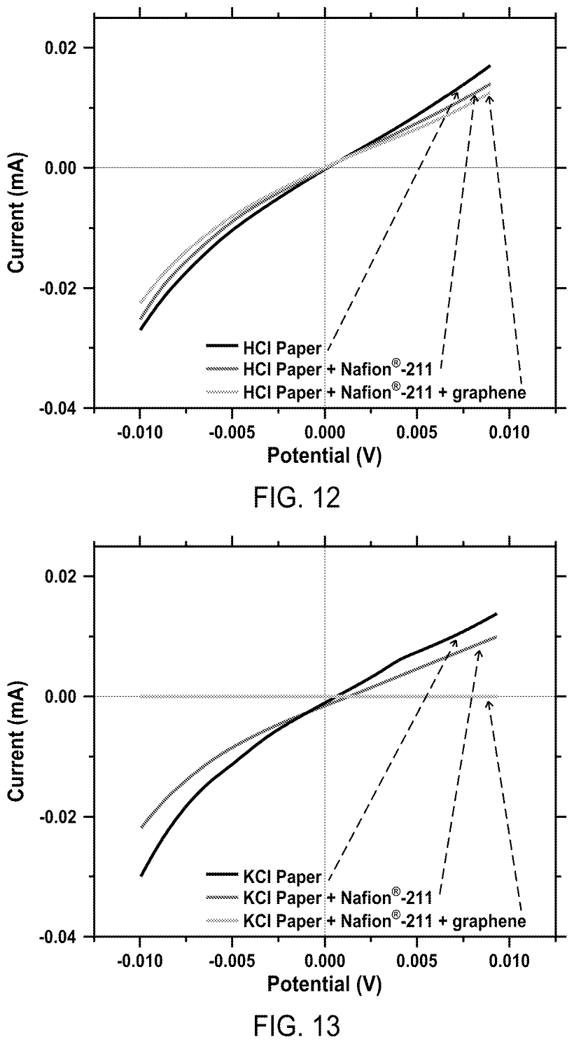

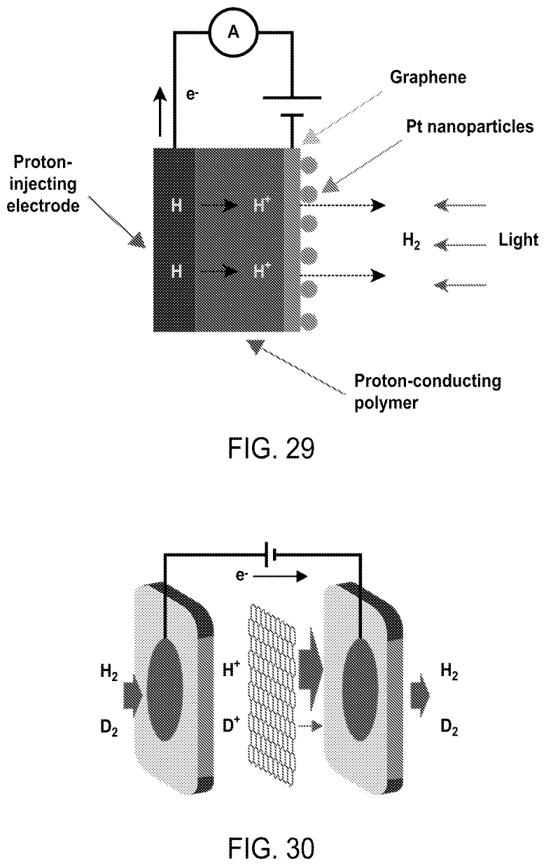

In another proton-deuteron separation study, Bukola et al. used Nafion-graphene-Nafion polyelectrolyte-membrane (PEM)-style hydrogen pump cells (FIG. 30 and inset in FIG. 10) with active areas ˜2 cm×2 cm and measured proton conductance ˜29 S cm⁻² for graphene synthesized via chemical vapor deposition (CVD) (Bukola et al. J. Am. Chem. Soc. 2018, 140, 1743-1752). The proton to deuteron selectivity ˜14:1 in their study (FIG. 10 and FIG. 11) (Bukola et al. J. Am. Chem. Soc. 2018, 140, 1743-1752) was in agreement with prior studies that showed proton conductance ˜3 mS cm⁻² (FIG. 4 and FIG. 5) (Hu et al. Nature 2014, 516, 227-230; Lozada-Hidalgo et al. Science (80-.). 2016, 351, 68-70). Further, the introduction of porous filter papers wetted with electrolyte (HCl or KCl) between the Nafion (modified by appropriate cation exchange) and the electrodes (Ag/AgCl) in the membrane electrode assembly (MEA) allowed for probing potassium ion (K⁺) transport, which was found to be negligible compared to protons (FIG. 12 and FIG. 13), indicating the absence of macroscopic defects (Bukola et al. J. Am. Chem. Soc. 2018, 140, 1743-1752). However, proton transport through rare, naturally occurring atomic defects in graphene cannot be completely ruled out (Achtyl et al. Nat. Commun. 2015, 6, 6539).

These observations have profound ramifications for the entire research field since they indicate that the observed increase in proton conductance could not be attributed to defects in CVD graphene alone (since potassium-ion transport was negligible), and the device configuration and particularly the interfacing of graphene strongly influences experimentally measured proton conductance. The above observations have strongly revived interest in graphene as an atomically thin proton-exchange membrane with high temperature stability (up to 250-300° C. in air), ability to operate in dry environments (unlike Nafion), and dual functionality, i.e. membrane and conductive electrode (Karnik et al. Nature 2014, 516, 173-175). Hence the important fundamental research questions that need to be addressed to move the field forward are i) what are the main factors affecting proton transport through atomically thin graphene membranes?, ii) what is the fundamental limit of proton transport through (defect-free) graphene?, iii) how can selective proton transport be manipulated and maximized in atomically thin graphene membranes?, and iv) can facile and scalable processes be developed to synthesize atomically thin graphene membranes with high proton flux?

Discussion

Quantum tunneling of thermal protons has been suggested (based on DFT calculations) as a plausible mechanism to explain the experimentally observed selective transport of protons through atomically thin graphene membranes (Hu et al. Nat. Nanotechnol. 2018, 13, 468-472; Holmes et al. Adv. Energy Mater. 2017, 7, 1-7; Bukola et al. J. Am. Chem. Soc. 2018, 140, 1743-1752; Lozada-Hidalgo et al. Science (80-.). 2016, 351, 68-70; Lozada-Hidalgo et al. Nat. Commun. 2017, 8, 15215; Poltaysky et al. J. Chem. Phys. 2018, 148, 204707; Feng et al. J. Phys. Chem. Lett. 2017, 8, 6009-6014). The quantum tunneling behavior of thermal protons can potentially be influenced by manipulating the electronic bonding environment and/or surface charge on monolayer graphene via functionalization.

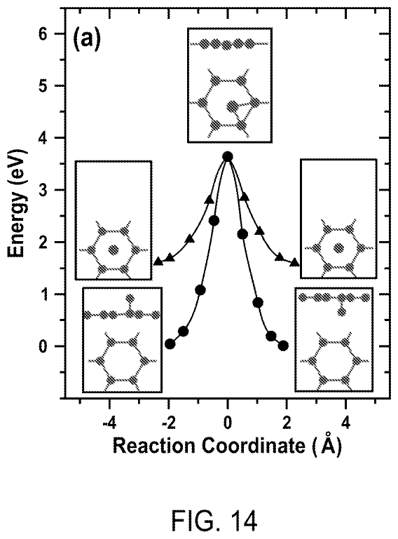

DFT calculations indeed suggest that hydrogenation of the graphene lattice (e.g., to form “graphene”) destabilizes the initial state (a deep-lying chemisorption state) and expands the 2D honeycomb lattice through which the protons penetrate, thereby decreasing the energy barrier for proton transport from >3 eV to <1 eV (FIG. 14) (Feng et al. J. Phys. Chem. Lett. 2017, 8, 6009-6014). However, experimental evidence remains elusive.

Quantum tunneling based accelerated (via electrostatic potential effects) thermal proton transport can be produced via dissimilar functionalization of the two surfaces of monolayer graphene to form “Janus graphene” (FIG. 3).

The goal is to elucidate proton transport mechanisms through monolayer graphene membranes, specifically the influence of surface charge on quantum tunneling of thermal protons. Here, graphene functionalization can be leveraged to further the understanding of proton transport mechanisms through atomically thin membranes.

The experiments systematically explore the influence of surface charge on proton transport through monolayer graphene via selective functionalization of the graphene surfaces. Monolayer graphene, halogenated graphene (e.g., fluorinated graphene), and hydrogenated graphene (graphene) are used as model systems to systematically probe the effect of surface charge on proton transport (via quantum tunneling) through the atomically thin lattice to elucidate the influence of surface charge on proton transport through monolayer graphene.

High Quality Monolayer Graphene Synthesis

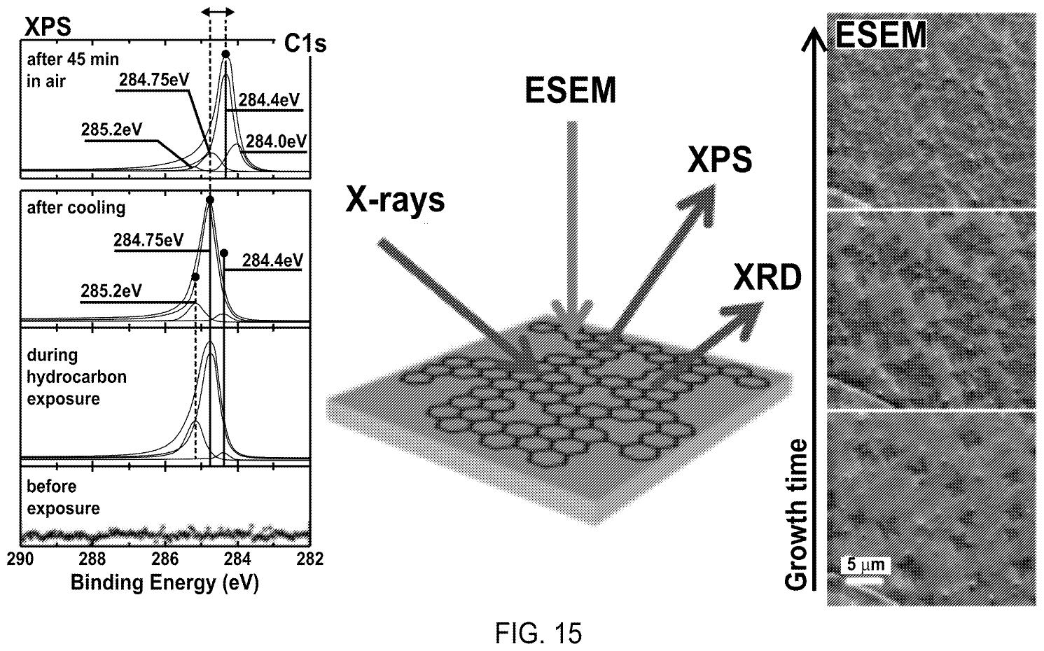

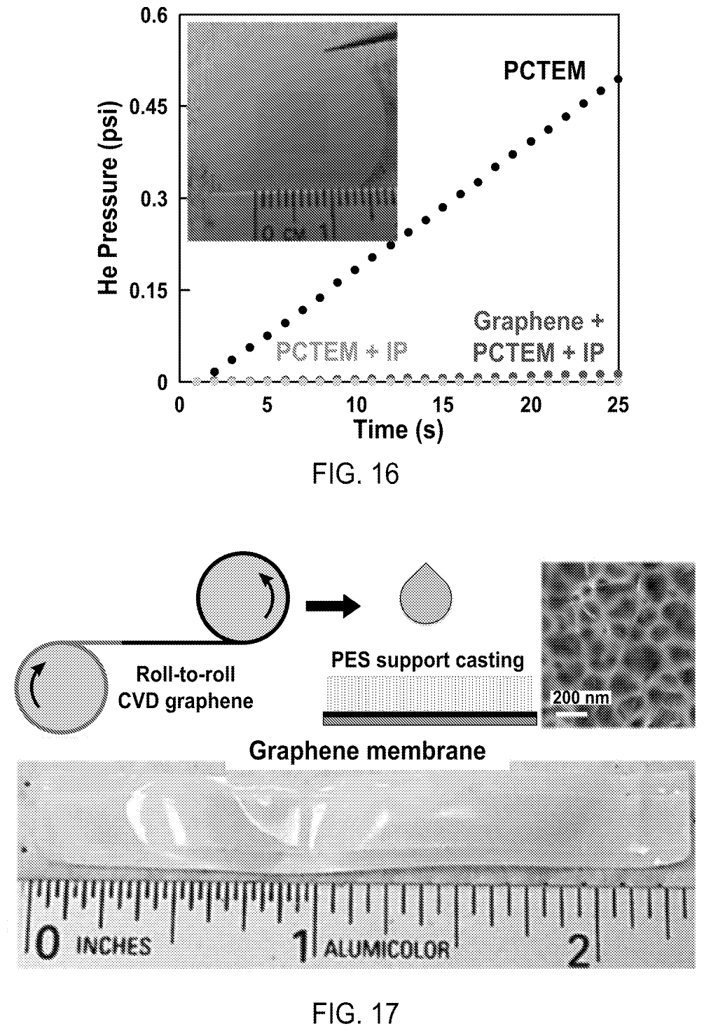

High-quality monolayer graphene is synthesized on commercially available polycrystalline Cu foils using chemical vapor deposition (CVD) processes that were previously developed based on detailed time- and process-resolved in-situ observations during graphene growth (FIG. 15) (Kidambi et al. Nano Lett. 2013, 13, 4769-4778), specifically for centimeter-scale atomically thin membrane and gas-barrier applications (membrane-grade graphene, FIG. 16) (Kidambi et al. Nanoscale 2017, 9, 8496-8507; Kidambi et al. ACS Appl. Mater. Interfaces 2018, 10, 10369-10378; Kidambi et al. Adv. Mater. 2017, 29, 1700277; Kidambi et al. Adv. Mater. 2018, 1804977) that have been extended to scalable roll-to-roll processing approaches (FIG. 17) (Kidambi et al. ACS Appl. Mater. Interfaces 2018, 10, 10369-10378).

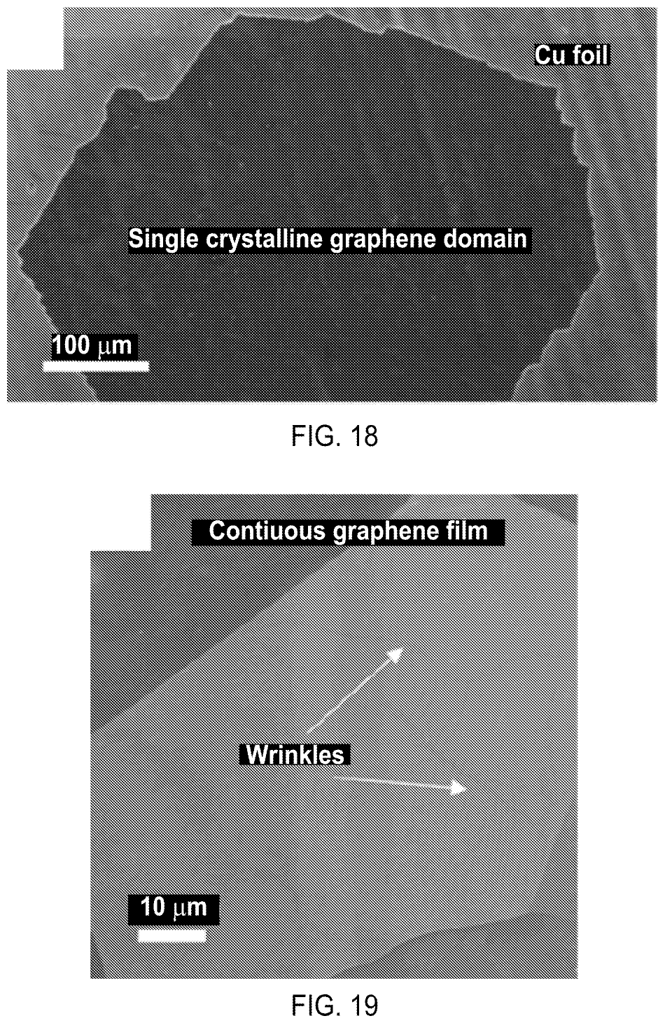

Specifically, cold-rolled polycrystalline Cu foil (18 μm thick, 99.9% purity, JX Holding HA) is pre-cleaned via sonication in 10% nitric acid solution to remove surface oxide layer and/or any surface contaminants from foil processing, followed by multiple rinses in de-ionized water and drying (Kidambi et al. Nanoscale 2017, 9, 8496-8507; Kidambi et al. ACS Appl. Mater. Interfaces 2018, 10, 10369-10378; Kidambi et al. Adv. Mater. 2017, 29, 1700277; Kidambi et al. Adv. Mater. 2018, 1804977). The pre-cleaned Cu foil is loaded into a custom-built CVD reactor, heated to 1050° C. in H₂ atmosphere under low pressure conditions, and annealed for 60 min to allow for grain growth of the catalytic Cu substrate. Post-annealing, CH₄ is added to the annealing environment to nucleate and grow graphene (Kidambi et al. Nanoscale 2017, 9, 8496-8507; Kidambi et al. ACS Appl. Mater. Interfaces 2018, 10, 10369-10378; Kidambi et al. Adv. Mater. 2017, 29, 1700277; Kidambi et al. Adv. Mater. 2018, 1804977). By controlling the growth time and composition of H₂ and CH₄ mixture, large single crystalline individual graphene domains free of grain boundaries and associated defects (FIG. 18), as well as continuous high-quality polycrystalline films (FIG. 19) (Kidambi et al. Nanoscale 2017, 9, 8496-8507; Kidambi et al. ACS Appl. Mater. Interfaces 2018, 10, 10369-10378; Kidambi et al. Adv. Mater. 2017, 29, 1700277; Kidambi et al. Adv. Mater. 2018, 1804977), are synthesized.

Post synthesis, CVD graphene is characterized using SEM for film coverage, homogeneity, and uniformity (FIG. 18 and FIG. 19) and Raman spectroscopy for film quality (FIG. 21). Preliminary results show the feasibility of high-quality single crystalline monolayer graphene domain and continuous-graphene-film synthesis (Kidambi et al. Nanoscale 2017, 9, 8496-8507; Kidambi et al. ACS Appl. Mater. Interfaces 2018, 10, 10369-10378; Kidambi et al. Adv. Mater. 2017, 29, 1700277; Kidambi et al. Adv. Mater. 2018, 1804977).

Device Fabrication and Measuring Proton Transport

Post high-quality monolayer graphene synthesis and selective functionalization of the graphene surfaces, three different types of devices are fabricated and proton transport is thoroughly characterized.

Liquid Phase Proton Transport Across Suspended Graphene Membranes

For liquid phase proton transport measurements, the synthesized high-quality continuous film of monolayer graphene on Cu (FIG. 19) is suspended over ˜2-10 μm diameter aperture in a Si, SiO₂, or Si₃N₄ wafer or TEM grids with a single aperture using well-developed polymer-free transfer methods to minimize contamination of the graphene surface (Kidambi et al. Nanoscale 2017, 9, 8496-8507; Kidambi et al. Adv. Mater. 2017, 29, 1700277; Kidambi et al. Adv. Mater. 2017, 29).

The approach comprises gently contacting the graphene on Cu with the target substrate followed by careful etching of the Cu to achieve graphene transfer to the target substrate (Kidambi et al. Nanoscale 2017, 9, 8496-8507; Kidambi et al. Adv. Mater. 2017, 29, 1700277; Kidambi et al. Adv. Mater. 2017, 29). The suspended graphene on wafer/TEM grid is mounted between side-by-side diffusion cells with 0.1 M HCl solution on either side (inset in FIG. 7) (Hu et al. Nat. Nanotechnol. 2018, 13, 468-472). Ag/AgCl electrodes on either side of the membrane are used to measure ionic current as a function of applied bias after sealing the graphene edges on the wafer/TEM grid with epoxy to prevent leakage (inset in FIG. 7) (Hu et al. Nat. Nanotechnol. 2018, 13, 468-472).

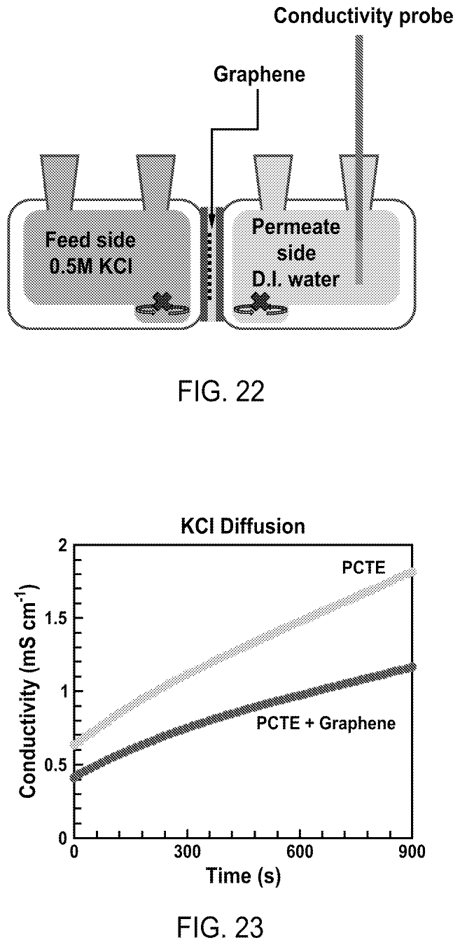

Additionally, diffusion-driven flow of KCl is measured across the suspended membranes using a well-developed procedure to quantify leakage across sub-nanometer scale defects in graphene (FIG. 22-FIG. 23) (Kidambi et al. Nanoscale 2017, 9, 8496-8507; Kidambi et al. Adv. Mater. 2017, 29, 1700277; Kidambi et al. Adv. Mater. 2017, 29). Here, diffusion of KCl is measured by filling one side of the diffusion cell with 0.5 M KCl solution and monitoring the increase in conductivity on the other side filled with de-ionized water with the help of a conductivity probe (FIG. 22-FIG. 23) (Kidambi et al. Nanoscale 2017, 9, 8496-8507; Kidambi et al. Adv. Mater. 2017, 29, 1700277; Kidambi et al. Adv. Mater. 2017, 29; Kafiah et al. Desalination 2016, 388, 29-37). As a control, large-area single crystalline graphene domains (FIG. 18) free of grain boundaries and associated defects are also measured.

The main advantage of the liquid phase measurement set-up is that it allows for direct measurements of areal conductivity of protons by minimizing any convoluting effects that could arise in other devices involving interfacing graphene with Nafion.

Nafion-Graphene-Nafion Sandwich Devices

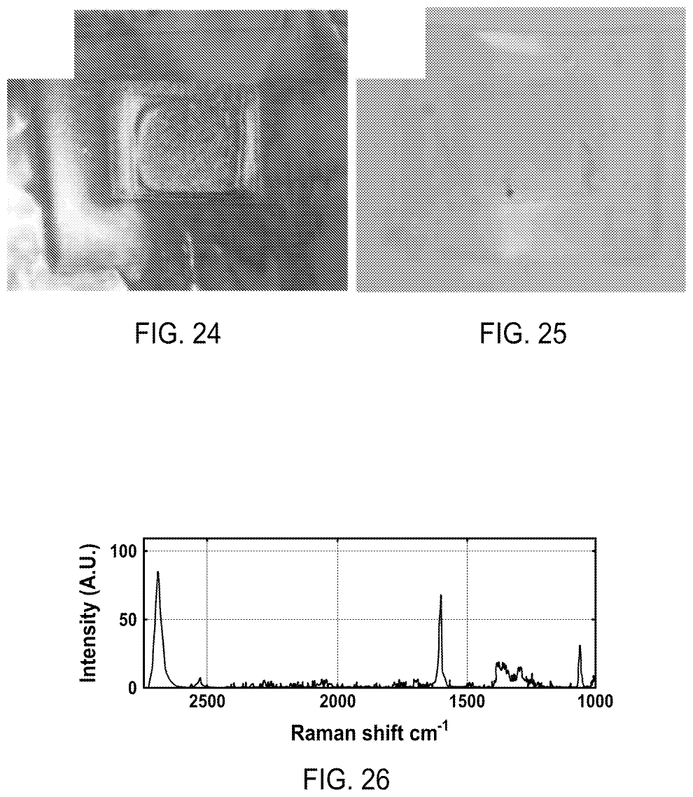

For Nafion-graphene-Nafion sandwich proton pump devices, a thin layer of 5% Nafion solution is spin coated on the CVD graphene on Cu foil and allowed to dry (Hu et al. Nat. Nanotechnol. 2018, 13, 468-472; Bukola et al. J. Am. Chem. Soc. 2018, 140, 1743-1752). Post drying, a ˜2 cm×2 cm Nafion layer (25 μm thick—Nafion 212 or 50 μm thick—Nafion 211) is hot-pressed at 140° C. on top of the similarly sized Nafion layer on graphene (FIG. 24) (Hu et al. Nat. Nanotechnol. 2018, 13, 468-472; Bukola et al. J. Am. Chem. Soc. 2018, 140, 1743-1752). Subsequent acid etch of the Cu foil, followed by multiple rinses in de-ionized water allows clean transfer of graphene to Nafion (FIG. 25) (Hu et al. Nat. Nanotechnol. 2018, 13, 468-472; Bukola et al. J. Am. Chem. Soc. 2018, 140, 1743-1752). Graphene transfer to Nafion is confirmed using Raman spectroscopy (FIG. 26) with the characteristic 2D peak −2700 cm⁻¹ and G peak −1600 cm⁻¹.

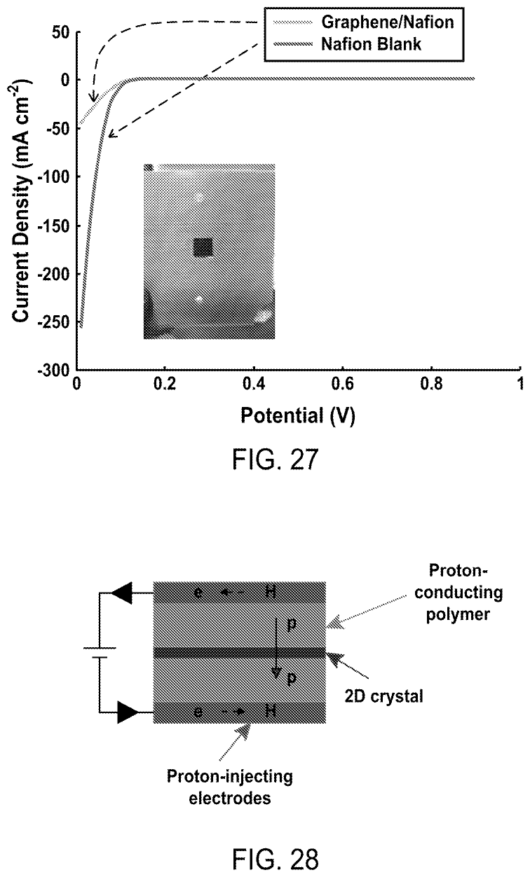

Next, an additional layer of Nafion is spin coated on the exposed graphene side, followed by hot pressing another layer of Nafion (identical in properties to the 1^{st} layer underneath graphene) to form a Nafion-graphene-Nafion sandwich (FIG. 28 and schematics in FIG. 4 and FIG. 10) (Hu et al. Nat. Nanotechnol. 2018, 13, 468-472; Bukola et al. J. Am. Chem. Soc. 2018, 140, 1743-1752). Finally, carbon-cloth electrodes coated with 4 mg/cm² of Pt black are added on both sides of the Nafion-graphene-Nafion structure to form a polyelectrolyte membrane (PEM)-style hydrogen pump cell (Bukola et al. J. Am. Chem. Soc. 2018, 140, 1743-1752). The PEM-style hydrogen pump cells are tested in a custom-built miniaturized fuel cell test set-up at 25° C. with hydrogen humidified with water vapor (Bukola et al. J. Am. Chem. Soc. 2018, 140, 1743-1752). Current-voltage curves are acquired using a potentiostat in linear sweep or cyclic voltammetry setting for a range of temperatures from 25-80° C. to obtain an activation energy from Arrhenius plots (FIG. 10-FIG. 13) (Bukola et al. J. Am. Chem. Soc. 2018, 140, 1743-1752; Bukola et al. Electrochim. Acta 2019, 296, 1-7). Preliminary results indicate the feasibility of fabricating PEM-style hydrogen pump cells (FIG. 27) (Bukola et al. J. Am. Chem. Soc. 2018, 140, 1743-1752; Bukola et al. Electrochim. Acta 2019, 296, 1-7).

Next, porous filter papers wetted with KCl are introduced between the Nafion (modified by K exchange) and the electrodes (changed to Ag/AgCl) to quantify potassium-ion transport as a measure of leakage through areas without graphene (Bukola et al. J. Am. Chem. Soc. 2018, 140, 1743-1752; Bukola et al. Electrochim. Acta 2019, 296, 1-7). Devices without graphene are measured as controls for these experiments. Finally, devices ˜100 μm×100 μm using single crystalline graphene domains (FIG. 18) free of grain boundaries and associated defects are fabricated and tested for an effective comparison.

Nafion-Graphene-Pt Device with Mass Spectrometry

For Nafion-graphene-Pt hydrogen pump devices, a high-quality monolayer-graphene film, ˜2 cm×2 cm, is transferred to a Nafion layer (25 μm thick—Nafion 212 or 50 μm thick—Nafion 211) via hot-pressing at 140° C., followed by acid etch of the Cu foil and multiple rinses in de-ionized water (FIG. 24-FIG. 26) (Hu et al. Nat. Nanotechnol. 2018, 13, 468-472; Bukola et al. J. Am. Chem. Soc. 2018, 140, 1743-1752). Next, 1-2 nm of Pt is evaporated on graphene on Nafion to form a Nafion-graphene-Pt stack and graphene is electrically contacted with palladium hydride electrodes (FIG. 29 and schematics in FIG. 7 and FIG. 8) (Hu et al. Nat. Nanotechnol. 2018, 13, 468-472; Bukola et al. J. Am. Chem. Soc. 2018, 140, 1743-1752). The Pt/graphene/Nafion device is sandwiched between two metal chambers (Hu et al. Nat. Nanotechnol. 2018, 13, 468-472; Bukola et al. J. Am. Chem. Soc. 2018, 140, 1743-1752). The Nafion side chamber is filled with hydrogen gas and liquid water, while the Pt side is under vacuum and connected to a mass spectrometer (Hu et al. Nat. Nanotechnol. 2018, 13, 468-472; Bukola et al. J. Am. Chem. Soc. 2018, 140, 1743-1752). Current vs Voltage characteristics are measured on these devices to quantify the hydrogen transport through graphene, while mass spectrometry is used to quantify hydrogen produced via proton transport through monolayer graphene (Hu et al. Nat. Nanotechnol. 2018, 13, 468-472; Bukola et al. J. Am. Chem. Soc. 2018, 140, 1743-1752). Additionally, mass spectrometry is used to quantify any leakage through defects or tears in graphene by spiking the input chamber (Nafion side) with methanol and observing cross over (Holmes et al. Adv. Energy Mater. 2017, 7, 1-7). As controls, devices without graphene are measured and devices ˜100 μm×100 μm using single crystalline graphene domains are fabricated and tested (FIG. 18).

A direct and exhaustive comparison of proton transport characteristics across the three different device configurations, different surface functionalization, temperature dependence (to compute activation energy), and relevant controls allows for the development of detailed fundamental insights on the effect of surface charge on proton transport through the graphene lattice (Hu et al. Nat. Nanotechnol. 2018, 13, 468-472; Bukola et al. J. Am. Chem. Soc. 2018, 140, 1743-1752).

Proton Transport Across Functionalized Graphene

Advances in graphene functionalization are leveraged to further the understanding of proton transport mechanisms through atomically thin membranes (Nair et al. Small 2010, 6, 2877-2884; Li et al. ACS Nano, 2011, 5, 5957-5961; Elias et al. Science (80-.). 2009, 323, 610-613). To probe the influence of surface charge on the proton conductance of graphene, CVD graphene surfaces are functionalized with F (−ve charge) and H (+ve charge) to form fluorographene and graphane, respectively (Nair et al. Small 2010, 6, 2877-2884; Li et al. ACS Nano, 2011, 5, 5957-5961; Elias et al. Science (80-.). 2009, 323, 610-613). Testing both ends of the functionalization spectrum allows for the development of a fundamental understanding of the effect of surface charge on proton transport through the graphene lattice.

Specifically, fluorographene is synthesized by exposing high-quality monolayer graphene to XeF₂ at 70° C. for 1-40 hours (Nair et al. Small 2010, 6, 2877-2884). The reaction is performed in a polytetrafluoroethylene (PTFE) container in a glovebox to avoid formation of HF from moisture in the ambient air and, at such low temperatures, the formation of copper fluoride is not expected (Nair et al. Small 2010, 6, 2877-2884). For suspended graphene membrane devices, the functionalization process is carried out after suspending graphene on the aperture in rigid substrates. If Si in the substrate gives rise to compatibility issues with the fluorination process (Nair et al. Small 2010, 6, 2877-2884), graphene suspended on apertures in Au foil can be used or the Si based substrates can be coated by atomic layer deposition of alumina or hafnia prior to graphene transfer.

For devices that require interfacing graphene with Nafion, initially high-quality monolayer CVD graphene on Cu is subjected to functionalization of the side of the graphene away from the Cu foil and at such low temperatures (˜70° C.) that the formation of copper fluoride is not expected (Nair et al. Small 2010, 6, 2877-2884). After transfer of the one-side-fluorinated graphene to Nafion, the other side of graphene that was previously in contact with the copper foil is subjected to functionalization. Fluorographene is known to be inert and stable up to 400° C. in air and hence issues with material stability during device fabrication are not anticipated 9 Nair et al. Small 2010, 6, 2877-2884).

Additionally, photochemical chlorination of graphene can also be used (Li et al. ACS Nano, 2011, 5, 5957-5961). Interestingly, chlorination allows for a reduction in integrated electron density on the graphene surface compared to fluorination, without changing the amount of negative charge (Li et al. ACS Nano, 2011, 5, 5957-5961).

For hydrogenation of graphene to form graphane, CVD graphene is placed inside a “cold” hydrogen plasma (0.1 mbar, 10% H₂ in Ar) using a side extension chamber to the Harrick Plasma system, such that the graphene is at least 30 cm away from the plasma to avoid damage from energetic ions (Elias et al. Science (80-.). 2009, 323, 610-613). Similar to fluorination, hydrogenation is performed in 2 steps for each surface of graphene for devices that require interfacing with Nafion and a single step for suspended graphene membranes. Hydrogenated graphene is known to be stable in air for days and hence issues with material stability during device fabrication are not anticipated (Elias et al. Science (80-.). 2009, 323, 610-613).

The extent of functionalization is characterized by X-ray photoelectron spectroscopy (XPS), Raman spectroscopy, and the resulting structures imaged at atomic resolution by scanning tunneling microscopy (STM) and scanning transmission electron microscopy (STEM). Insights into material structure can result from atomic resolution images, specifically in the context of Janus graphene.

Proton transport through fluorographene and graphane is tested using methods similar to graphene as described earlier and as controls devices without graphene in both sets of device configurations are measured. Finally, single crystalline graphene domains are functionalized to fabricate and test devices ˜100 μm×100 μm.

Probing Proton Transport Though Atomically Thin Janus Graphene Membranes

Based on the insights obtained from the experiments described above, graphene is selectively functionalized with different species on either side to form atomically thin “Janus” graphene membranes (FIG. 3) (Zhang et al. Nat. Commun. 2013, 4, 1443-1447) with the aim of accelerating (via electrostatic potential effects) thermal-proton transport through the 2D lattice using surface charge. Theoretical studies have suggested quantum tunneling of thermal protons through the 2D lattice as a plausible transport mechanism (Poltaysky et al. J. Chem. Phys. 2018, 148, 204707), and functionalizing the graphene surface with hydrogen to form graphane can facilitate proton transport by decreasing the energy barrier from >3 eV to <1 eV (FIG. 14) (Feng et al. J. Phys. Chem. Lett. 2017, 8, 6009-6014).

Here, in addition to graphane and fluorographene, graphene with a) only one side functionalized with F or H and b) one side functionalized with F and the other side with H is synthesized and proton conductance is tested through said graphene. Functionalization methods described above are used to synthesize Janus graphene and methods described above are used to measure proton transport through Janus graphene membranes.

Additionally, the surface charge that protons encounter first during transport is changed by physically flipping the membrane in each of the three device configurations, or, alternatively, the cathode and anode in the Nafion-graphene-Nafion setup can be interchanged (FIG. 30). In these experiments, the configuration where the protons encounter the F terminated side upstream and H terminated side downstream can provide accelerated proton transport due to electrostatic potential effects in the direction of the applied potential.

Here, the order of proton transport experiments with Janus graphene membranes is prioritized based on insights from theoretical calculations.

Outcomes

The experiments can shed light on the fundamental mechanisms governing the transport of protons through atomically thin membranes. Specifically, the experiments can provide insights on the influence of surface charge on graphene on quantum tunneling based transport of thermal protons and can aid the development of next-generation of proton selective membranes.

The experiments can investigate the predicted proton flux increase for “graphane” and provide insights on activation energies for proton transport across halogenated graphene, hydrogenated graphene, and Janus graphene. The research can offer fundamental insights into the atomic structure of Janus graphene.

### Example 2

The published calculations for proton transport through graphene do not correspond to transport of a proton through graphene; Instead, they describe the transport of a hydrogen atom through p-type graphene (Miao et al. Phys. Chem. Chem. Phys. 2013, 15, 16132; Poltaysky et al. J. Chem. Phys. 2018, 148, 204707; Feng et al. J. Phys. Chem. Lett. 2017, 8, 6009-6014; Achtyl et al. Nat. Commun. 2015, 6, 6539; Kroes et al. Phys. Chem. Chem. Phys. 2017, 19, 5813-5817; Zhang et al. J. Phys. Chem. Lett. 2016, 7, 3395-3400). This is a technical, but significant point: the calculations were repeated using a supercell containing monolayer graphene and a single H atom. Removing an electron from such a supercell does not convert the H atom to a proton, as assumed by prior theory. Instead, the H atom remains neutral while a delocalized hole (per supercell) appears at the Fermi energy. Thus, the calculated lower energy barrier corresponds to transport of H atoms in p-type graphene instead transport of protons in undoped graphene (to maintain clarity, the term “proton transport” will continue to be used herein). Moreover, the energy barrier can be tuned by the doping level. It is in fact noteworthy that Nafion, a polymer that is used to coat graphene in proton-transport experiments (Hu et al. Nature 2014, 516, 227-230; Karnik et al. Nature 2014, 516, 173-175), is known to dope graphene p-type 9 Liu et al. Nanotechnology 2009, 20, 465605). As an H⁺ from Nafion approaches graphene, it turns into a neutral H. It is then neutral H atoms that transport through p-type graphene. Above room temperature, thermal activation dominates over tunneling and leads to the observed Arrhenius behavior (Tsetseris et al. Carbon N. Y. 2014, 67, 58-63; Miao et al. Phys. Chem. Chem. Phys. 2013, 15, 16132).

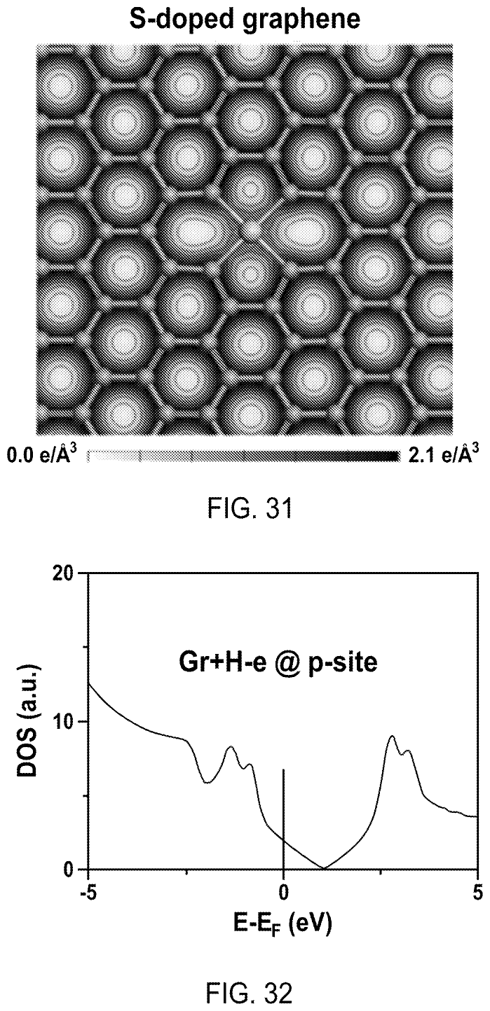

Prior theoretical/experimental work found that Si impurities in graphene have two stable configurations, replacing a single C atom (three-fold-coordinated Si) or replacing two adjacent C atoms (four-fold-coordinated Si) (Zhou et al. Phys. Rev. Lett. 2012, 109, 206803). Calculations were performed replacing two C atoms by S and the results indicated that the structure is stable and features two hexagonal rings that are significantly larger than the standard hexagonal rings of both pristine graphene and h-BN (FIG. 31). The calculations further predict that S atoms occupying a single C site can be converted to S atoms occupying two C sites by moderate annealing. In other prior work, p-type doping by B can occur at room temperature for graphene on Ru and Cu substrates and was experimentally verified for Ru (Pan et al. Nano Lett. 2015, 15, 6464-6468). Thus, co-doping by S and B is can provide independent control of both the pore size and p-type doping, the two factors that control the energy barrier and hence the rate for proton transport. Se should work the same way as S, but with perhaps even larger pores, while P should work the same way as S, but would also dope p-type simultaneously (verified by DFT calculations).

Combined with extensive experimental background in 2D material synthesis, fabricating fully functional, large-area, nanoporous, atomically thin dialysis membranes (Kidambi et al. Adv. Mater. 2017, 29, 1700277), large-area atomically thin gas barriers (Kidambi et al. Nanoscale 2017, 9, 8496-8507), direct synthesis of nanoporous graphene (Kidambi et al. Adv. Mater. 2018, 1804977), in probing sub-nanometer size intrinsic defects in large-area single-crystalline graphene membranes (Kidambi et al. Adv. Mater. 2017, 29, 1605896), and in developing roll-to-roll manufacturing processes for atomically thin graphene membranes (Kidambi et al. ACS Appl. Mater. Interfaces 2018, 10, 10369-10), the above possibilities can provide deliberate and precise manipulation of the energy barrier for proton transport through graphene. The experimental research herein is focused on S, which is inexpensive and non-toxic, developing facile in-situ doping during graphene synthesis via chemical vapor deposition (CVD) processes. S doping is optimized by leveraging homogeneous gas-phase mixing of H₂S with graphene precursors (CH₄ and H₂) (Kidambi et al. ACS Appl. Mater. Interfaces 2018, 10, 10369-10) and developing an annealing process to yield the desirable S-dopant configuration (FIG. 31). The effect of increasing the S-dopant concentration, doping by B, and, finally, co-doping by S and B is systematically probed in pursuit of the most promising combinations.

Atomic-resolution scanning-transmission-electron microscopy (STEM) and scanning tunneling microscopy and spectroscopy (STM/STS) in conjunction with pertinent DFT calculations are used to obtain detailed insights into S and other dopant incorporation/clustering in the graphene lattice. The resulting insights are used to develop roll-to-roll CVD of S-doped and B co-doped graphene for atomically thin, high-flux proton exchange membranes (Kidambi et al. ACS Appl. Mater. Interfaces 2018, 10, 10369-10). Proton transport is characterized using Nafion-graphene-Nafion sandwich proton pump devices (FIG. 4) and ionic current measurements in a liquid-cell with suspended graphene membranes (FIG. 7). Depending on the results, doping with other atoms such as P or Se will be investigated. As the experiments proceed, DFT calculations are employed to gain further insights into the transport process with continuous feedback between theory and experiments, aiming to maximize and tune the proton transport rate.

This project can lead to insights and information on the influence of S-doping and S/B co-doping on proton transport through graphene membranes. The project can further the development of scalable processes for manufacturing next-generation proton exchange membranes for fuel cells (Holmes et al. Adv. Energy Mater. 2017, 7, 1-7), hydrogen purification (Lozada-Hidalgo et al. Nat. Nanotechnol. 2018, 13, 300-303), isotope separation (Hu et al. Nature 2014, 516, 227-230; Lozada-Hidalgo et al. Science (80-.). 2016, 351, 68-70; Bukola et al. J. Am. Chem. Soc. 2018, 140, jacs.7b10853), environmental remediation (Hu et al. Nature 2014, 516, 227-230; Lozada-Hidalgo et al. Science (80-.). 2016, 351, 68-70; Bukola et al. J. Am. Chem. Soc. 2018, 140, jacs.7b10853), and membrane electrode applications.

On the theory side, several papers on hydrogen and proton transport through graphene have been published (Tsetseris et al. Carbon N. Y. 2014, 67, 58-63; Miao et al. Phys. Chem. Chem. Phys. 2013, 15, 16132; Poltaysky et al. J. Chem. Phys. 2018, 148, 204707; Feng et al. J. Phys. Chem. Lett. 2017, 8, 6009-6014; Achtyl et al. Nat. Commun. 2015, 6, 6539; Kroes et al. Phys. Chem. Chem. Phys. 2017, 19, 5813-5817; Zhang et al. J. Phys. Chem. Lett. 2016, 7, 3395-3400; Kidambi et al. Adv. Mater. 2017, 29, 1700277). As already mentioned, two papers (Tsetseris et al. Carbon N. Y. 2014, 67, 58-63; Miao et al. Phys. Chem. Chem. Phys. 2013, 15, 16132) were published prior to the first experimental paper on proton transport (Hu et al. Nature 2014, 516, 227-230). In these and the subsequent papers, energy barriers were calculated using the climbing-nudged-elastic-band method (Mills et al. Phys. Rev. Lett. 1994, 72, 1124-1127; Henkelman et al. J. Chem. Phys. 2000, 113, 9978-9985) or quantum molecular dynamics (Poltaysky et al. J. Chem. Phys. 2018, 148, 204707). Quantum effects for the proton (tunneling and zero-point energy) were included using several methods (Poltaysky et al. J. Chem. Phys. 2018, 148, 204707; Feng et al. J. Phys. Chem. Lett. 2017, 8, 6009-6014; Zhang et al. J. Phys. Chem. Lett. 2016, 7, 3395-3400). A summary of the results is as follows. Starting with a hydrogen atom at the physisorbed site directly above the center of a six-member graphene ring, transport to the other side can occur along two different paths. In one path, the H atom is first diverted to one of the carbon atoms in the ring where it gets chemisorbed. From that site, it can transfer to the other side of the graphene sheet, but the pertinent energy barrier is high, ˜4.5 eV 9 Tsetseris et al. Carbon N. Y. 2014, 67, 58-63; Miao et al. Phys. Chem. Chem. Phys. 2013, 15, 16132). If the hydrogen is constrained to go through the ring, avoiding chemisorption, the energy barrier is lowered to below 3 eV (variations in the numbers exist because of different technical choices). The constrained path is justified by recognizing that in the experimental results, which employ Nafion or an aqueous coating on graphene, the chemisorption sites are likely to be blocked by bonded hydrogen. Indeed, calculations employing hydrogenation of the C atoms on the six-member ring found a lower energy barrier (Feng et al. J. Phys. Chem. Lett. 2017, 8, 6009-6014).

Additional lowering of the energy barrier was obtained by removing one electron from the computational supercell, which was interpreted to correspond to proton instead of atomic-hydrogen transport (Miao et al. Phys. Chem. Chem. Phys. 2013, 15, 16132; Poltaysky et al. J. Chem. Phys. 2018, 148, 204707; Feng et al. J. Phys. Chem. Lett. 2017, 8, 6009-6014; Achtyl et al. Nat. Commun. 2015, 6, 6539; Kroes et al. Phys. Chem. Chem. Phys. 2017, 19, 5813-5817; Zhang et al. J. Phys. Chem. Lett. 2016, 7, 3395-3400). The energy barrier is then reduced to 2.2 eV or 1.4 eV, depending on the path (Miao et al. Phys. Chem. Chem. Phys. 2013, 15, 16132). Inclusion of quantum effects for the proton (tunneling and zero-point energy) reduce the energy barrier by another 0.5 eV (Feng et al. J. Phys. Chem. Lett. 2017, 8, 6009-6014), bringing it in line with the experimental value of 0.8 eV 9 Hu et al. Nature 2014, 516, 227-230).

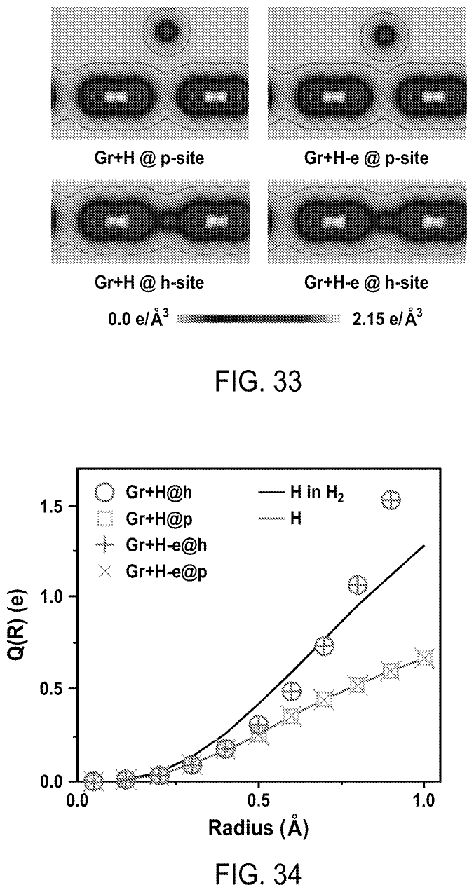

Calculations were performed that refute the interpretation of the published DFT results as describing the transport of protons through graphene. All published results are obtained using periodically repeated “supercells” that contain a graphene monolayer and a H atom and the energy barrier for transport through a hexagonal ring is calculated. Transport of a proton is then modeled by simply removing an electron from the supercell, with the expectation that this step creates a proton. Such calculations were repeated and the published numerical results were reproduced. However, examination of the total density of states (DOS) and the electron distribution around H at both the physisorbed site and at the center of the hexagonal carbon ring reveal a very different interpretation. The removal of an electron from each supercell simply introduces holes at the Dirac point, lowering the Fermi energy, i.e., the graphene sheet is doped p-type (FIG. 32). At the same time, the electron distribution around H and “proton” look indistinguishable (FIG. 33), i.e., in both cases essentially have a neutral H atom.

In order to quantify the net electronic charge associated with the positive nucleus in each case (hydrogen or “proton”), adoption of one of the many phenomenological “effective charges”, e.g., Mulliken, Hirschfeld, Bader charges, etc., which are based on different assumptions and are subject to ambiguities, was avoided (Manz et al. RSC Adv. 2016, 6, 47771-47801). Instead, the following robust procedure was adopted for examining deviations from charge neutrality in atoms (Luo et al. Phys. Rev. Lett. 2007, 99, 036402). The electron density was integrated in concentric spheres of increasing radius R around the nucleus, constructing a function Q(R). Q(R) is plotted in FIG. 34 for both a hydrogen and a “proton” at each of the two sites and compared with the corresponding Q(R) for a hydrogen in a H₂ molecule or free H, in both of which H is definitely neutral. These results confirm that removing an electron from a supercell leaves the H unaltered.

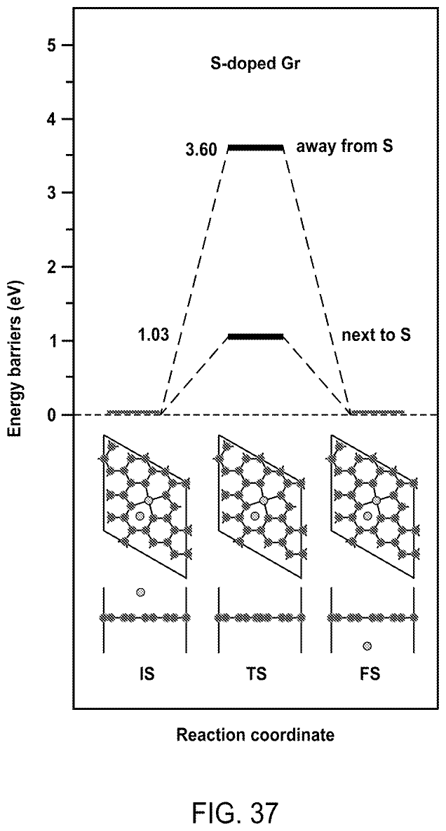

One more set of calculations was performed. A fraction of an electron was removed, which, by the above analysis, correspond to different p-doping levels and demonstrated a dependence of the energy barrier on the doping level (FIG. 33; for one doping level, a whole electron was removed from a corresponding larger supercell to check the accuracy of the fractional-electron model and found it to be adequate—red point in FIG. 33). Calculated energy barriers for H transport under different conditions in graphene are shown in FIG. 37 (numbers differ from some published numbers because of different technical choices).

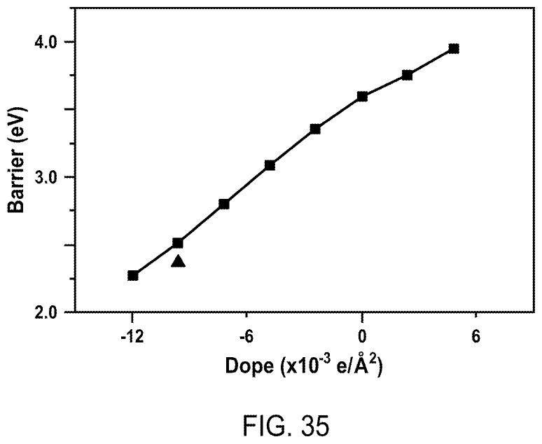

The net conclusion from the above theoretical results is that the lowering of the energy barrier for hydrogen transport through graphene that results from the removal of an electron from the computational supercell is simply indicative of a p-type-doping effect, not the transport of a proton. It should also be noted that “protons” in Nafion or aqueous solutions are not bare. Plots such as FIG. 35 were recently used to demonstrate that the net charge on so-called protons or H⁺ in water is a very tiny fraction of +1 (its value cannot be uniquely defined because there is no way to pick a unique radius for a sphere in which to integrate the electron density) (Zuluaga et al. ACS Omega 2017, 2, 4480-4487).

Using the above interpretation of the published numerical DFT results and the known fact that Nafion dopes graphene p-type (Liu et al. Nanotechnology 2009, 20, 465605), the experimental data on proton transport through graphene sandwiched between Nafion or in aqueous-solution layers is re-interpreted as follows (Hu et al. Nature 2014, 516, 227-230; Karnik et al. Nature 2014, 516, 173-175; Lozada-Hidalgo et al. Science (80-.). 2016, 351, 68-70; Holmes et al. Adv. Energy Mater. 2017, 7, 1-7; Lozada-Hidalgo et al. Nat. Nanotechnol. 2018, 13, 300-303; Bukola et al. J. Am. Chem. Soc. 2018, 140, jacs.7b10853; Lozada-Hidalgo et al. Nat. Commun. 2017, 8, 15215). So-called “protons” in Nafion or aqueous solutions are effectively hydrogen atoms with a minimal positive charge, which is sufficient for an electric field to drive them. The major factors that lower the energy barrier for “protons” coming through the Nafion are Nafion dopes graphene p-type and graphene is effectively hydrogenated so that the “protons” travel directly through the hexagonal rings without going through a chemisorbed state 9 Feng et al. J. Phys. Chem. Lett. 2017, 8, 6009-6014). The same factors influence proton transport when Nafion is replaced by HCl-containing aqueous solutions because the same hole doping effect of graphene is expected by any medium that contains nominal H⁺.

The above re-assessment of the theoretical and experimental data on H/H⁺ transport through graphene leads to the conclusion that there are three factors that control the rate of “proton transport” through graphene: i) hydrogenation of graphene to eliminate the chemisorption route for transporting H⁺, ii) p-type doping of graphene, and iii) the size of the pores. Hydrogenation can be accomplished by the supply of H to be transported even in a dry environment. To pursue the goal of maximizing the proton transport rate by optimizing the pore size and the p-type doping, the following recent findings and on DFT calculations motivated by these findings were considered.

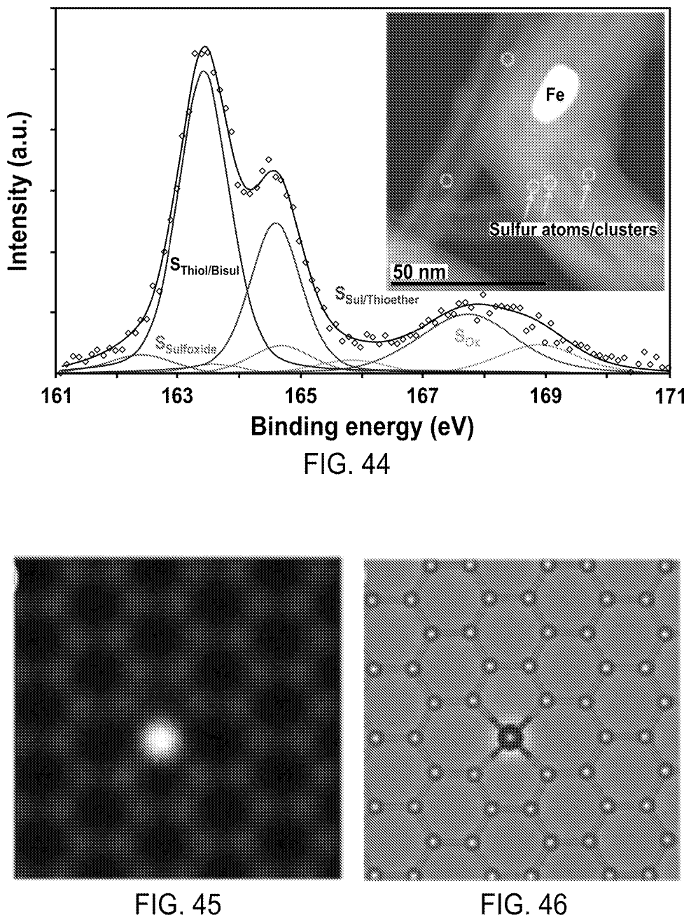

In 2012, Zhou et al. used STEM images, atomic-resolution electron-energy-loss spectroscopy (EELS), and DFT calculations to identify both three-fold-coordinated and four-fold-coordinated Si impurities in graphene (Zhou et al. Phys. Rev. Lett. 2012, 109, 206803). In the first case, Si replaces one C atom and rises slightly above the plane, while in the second case Si replaces two C atoms, resulting in two small five-member rings and two larger six-member rings (FIG. 45 and FIG. 46) (Zhou et al. Phys. Rev. Lett. 2012, 109, 206803). DFT calculations were performed for S and found that the same two configurations are stable. Furthermore, removal of a C atom next to a three-fold-coordinated S costs only 1.36 eV, which suggests that annealing at moderate temperatures would convert three-fold to the desired four-fold configurations (FIG. 31). Finally, DFT calculations were performed for the passing of H through the larger six-member rings next to S and found that, in a neutral supercell, the energy barrier drops from 3.6 eV in 6-C rings to 1.04 eV in the large S-containing rings (FIG. 44). Comparing with FIG. 37 for pristine and p-doped graphene, p-type doping of S-doped graphene can lead to further lowering of the energy barrier. Even though S has six valence electrons and replaces two C atoms with a total of eight valence electrons, it does not dope the graphene p-type (four of the six S electrons are used in the four S—C bonds and the remaining two play the role of the two p_{z} electrons of the missing two C atoms).

In 2015, Pan et al. used DFT calculations for graphene on a Ru substrate and predicted that a boron atom can push a carbon atom down toward the substrate and replace it with virtually no energy barrier, signaling a low-thermal-budget, p-type-doping process for graphene 9 Pan et al. Nano Lett. 2015, 15, 6464-6468). The prediction was verified for Ru substrates by experimental means, but DFT calculations also predicted that it should work just as well on more practical Cu substrates (Pan et al. Nano Lett. 2015, 15, 6464-6468). The energy barrier for H transport through the large hexagon next to a S impurity as in FIG. 31 was calculated to have a very low value of 1.04 eV. Inclusion of the nuclear-quantum-effect correction of ˜0.3 eV leads to an energy barrier of only 0.8 eV. Initial calculations for p-type graphene (B and S at equal concentrations) find that the barrier for transport through the large hexagon is of order 0.4 eV, approaching the barrier for h-BN. This barrier can further be tuned by controlling the concentrations of S and B.

Proton transport can be significantly increased and tuned by deliberate and precise manipulation of the pore size in the electron density distribution in monolayer graphene by doping with S atoms in a way that leads to primarily four-fold-coordinated S that replaces two adjacent C atoms (FIG. 31). The transport rate can further be enhanced and optimized by co-doping with B. In addition to S, other elements such as Si, P, Se can behave similarly to S.

A facile in-situ S doping during graphene synthesis is developed via scalable chemical vapor deposition (CVD) processes (Kidambi et al. ACS Appl. Mater. Interfaces 2018, 10, 10369-10378; Quan et al. Sci. Rep. 2015, 4, 5639), the fraction of four-fold-coordinated S structures by suitable post-processing such as annealing is optimized, and proton-transport measurements are pursued and optimized. The transport rate of S-doped graphene is further enhanced by pursuing co-doping with B. Pertinent DFT calculations are carried out to further elucidate the theoretical issues highlighted above and aid in interpreting experimental data and in designing subsequent experiments. The goal is to maximize and control the rate of hydrogen/proton transport through monolayer graphene and enable scalable roll-to-roll processes for manufacturing next-generation proton-exchange membranes.

Herein, prior advances in the synthesis of atomically thin membranes are leveraged, including: i) detailed time- and process-resolved in-situ observations during graphene growth via CVD (FIG. 15) (Kidambi et al. Nano Lett. 2013, 13, 4769-4778), ii) CVD approaches for realizing subnanometer defect free centimeter-scale atomically thin gas barriers with <2% He transport (FIG. 16) (Kidambi et al. ACS Appl. Mater. Interfaces 2018, 10, 10369-10378; Kidambi et al. Adv. Mater. 2018, 1804977; Kidambi et al. Adv. Mater. 2017, 29, 1700277; Kidambi et al. Nanoscale 2017, 9, 8496-8507), and iii) scalable roll-to-roll graphene CVD along with facile polymer casting for manufacturing large-area atomically thin graphene membranes (FIG. 17) (Kidambi et al. ACS Appl. Mater. Interfaces 2018, 10, 10369-10378).

The research builds on these advances and systematically explores the introduction and influence of the desired four-fold-coordinated S doping on proton transport through monolayer graphene membranes, both by doping only with S, relying on Nafion to provide p-type doping, and co-doping with B to achieve control of the p-type doping level. The fundamental scientific insights from the S doping and proton transport studies (specifically S and B doping concentrations and process parameters for maximizing proton flux) are used to develop scalable roll-to-roll advanced manufacturing processes for atomically thin high flux proton exchange membranes.

High-quality monolayer graphene with varying concentrations of uniformly distributed four-fold-coordinated S dopant atoms is synthesized. CVD processes are used since they are readily scalable and allow for the facile incorporation of a uniform distribution of dopant atoms by leveraging uniform mixing in the gas phase (Kidambi et al. Nano Lett. 2013, 13, 4769-4778; Kidambi et al. ACS Appl. Mater. Interfaces 2018, 10, 10369-10378).

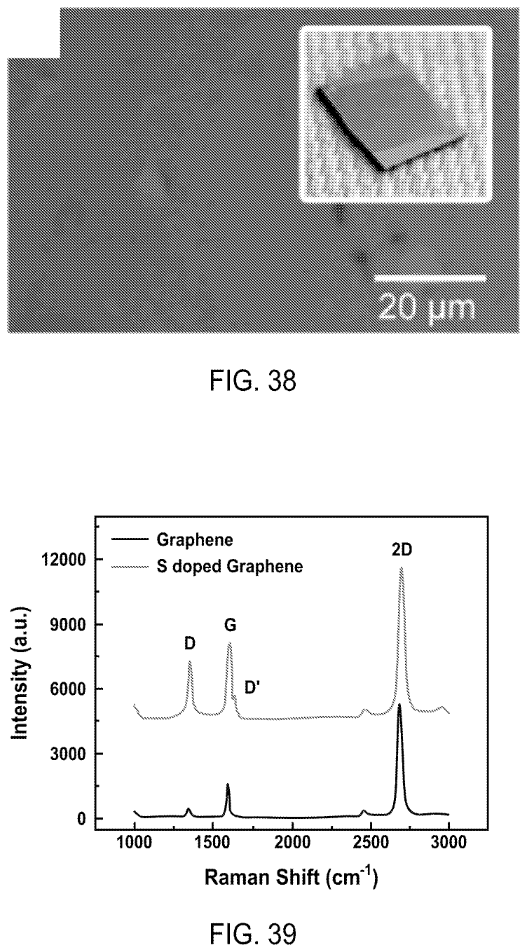

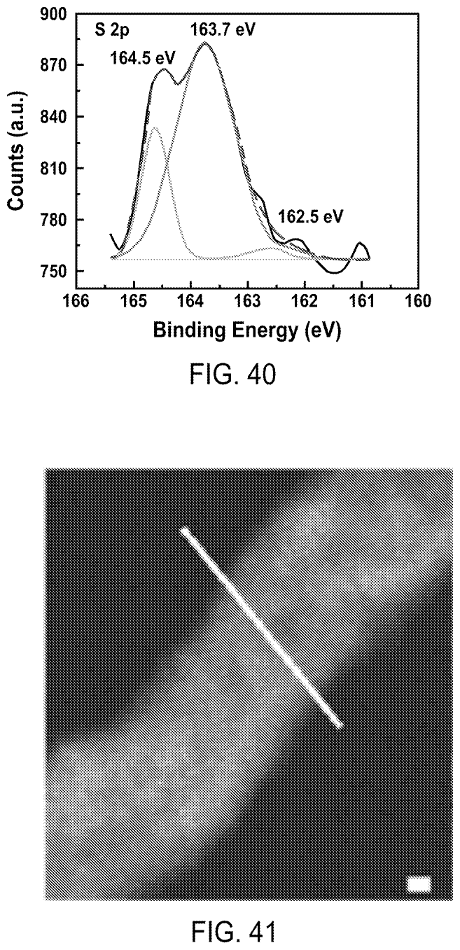

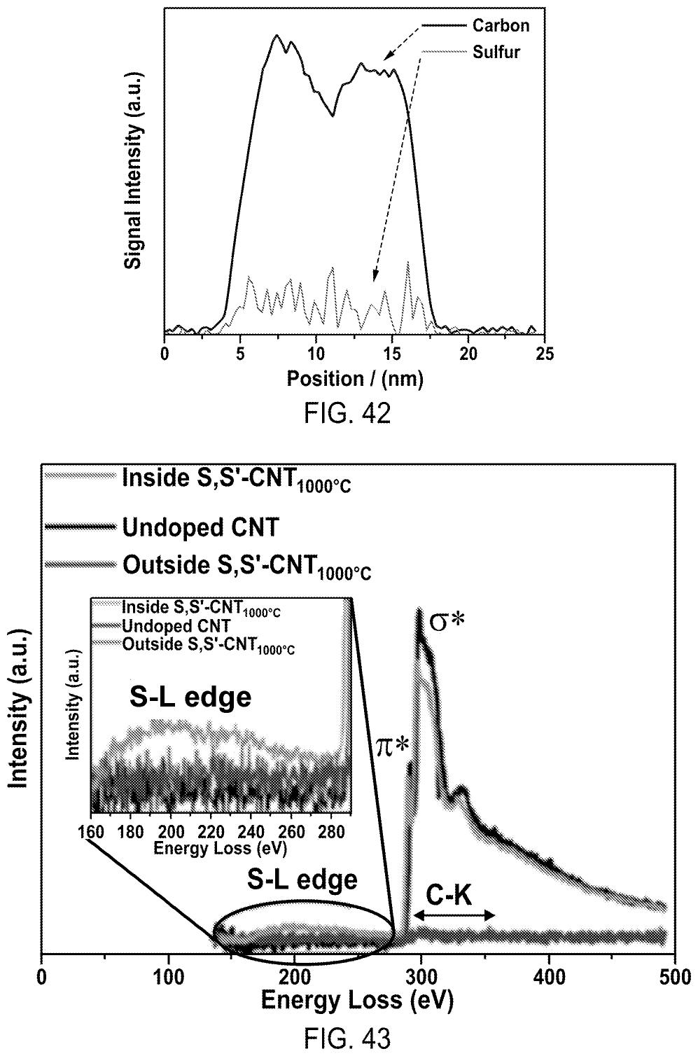

Prior reports on S-doping of graphene (FIG. 38-FIG. 40) (and carbon nanotubes (FIG. 41-FIG. 44) along with detailed X-ray photoelectron spectroscopy (XPS, FIG. 40 and FIG. 44) and EELS (FIG. 43) indicating the formation of C—S bonds, suggests the strong feasibility of incorporating S dopants into the graphene lattice via CVD (Gao et al. Nanotechnology, 2012, 23(27), 275605; Wang et al. ACS Appl. Mater. Interfaces 2018, 10, 5750-5759; Ito et al. Angewandte Chemie Int. Ed. 2015, 54(7), 2131-6; Hassani et al. RSC Adv. 2016, 6, 27158-27163; Liang et al. 2014 Symposium on Design, Test, Integration and Packaging of MEMS/MOEMS (DTIP); IEEE, 2014; 1-4; Liang et al. 2015 Transducers—2015 18th International Conference on Solid-State Sensors, Actuators and Microsystems (TRANSDUCERS); IEEE, 2015; 1421-1424; Choi et al. J. Korean Phys. Soc. 2016, 68, 1257-1261; El-Sawy et al. Adv. Energy Mater. 2016, 6, 1501966; Louisia et al. Catal. Commun. 2018, 109, 65-70). The fact that Si is known to naturally adopt the desired configuration (Zhou et al. Phys. Rev. Lett. 2012, 109, 206803), as discussed above, further corroborates the feasibility (FIG. 45, FIG. 46, and FIG. 31).

The synthesis of high-quality, continuous, but polycrystalline monolayer S-doped graphene films is carried out via CVD on commercially available cold-rolled polycrystalline Cu foil (18-36 μm thick, 99.9% purity, JX Holding HA) (Kidambi et al. ACS Appl. Mater. Interfaces 2018, 10, 10369-10378; Kidambi et al. Adv. Mater. 2018, 1804977; Kidambi et al. Adv. Mater. 2017, 29, 1700277; Kidambi et al. Nanoscale 2017, 9, 8496-8507). The Cu foils are pre-cleaned by sonication in 10-15% nitric acid solution, followed by sonication in de-ionized water to remove surface impurities including any surface oxides (Kidambi et al. ACS Appl. Mater. Interfaces 2018, 10, 10369-10378; Kidambi et al. Adv. Mater. 2018, 1804977; Kidambi et al. Adv. Mater. 2017, 29, 1700277; Kidambi et al. Nanoscale 2017, 9, 8496-8507). Next, the pre-cleaned foils are dried with laboratory nitrogen gas and loaded into a custom-built CVD reactor. The foil is heated to 1050° C. under low-pressure (˜1 Torr) in H₂ and annealed for 30-60 min (Kidambi et al. ACS Appl. Mater. Interfaces 2018, 10, 10369-10378; Kidambi et al. Adv. Mater. 2018, 1804977; Kidambi et al. Adv. Mater. 2017, 29, 1700277; Kidambi et al. Nanoscale 2017, 9, 8496-8507).

Post-annealing, CH₄ (precursor for C atoms in graphene) is added to H₂ for ˜15-30 min, to allow for nucleation and growth of monolayer graphene domains which eventually merge and form a continuous polycrystalline film (Kidambi et al. ACS Appl. Mater. Interfaces 2018, 10, 10369-10378; Kidambi et al. Adv. Mater. 2018, 1804977; Kidambi et al. Adv. Mater. 2017, 29, 1700277; Kidambi et al. Nanoscale 2017, 9, 8496-8507). S doping is achieved via introducing hydrogen sulfide gas (H₂S) diluted in Ar during the growth phase by mixing it with the CH₄ (Quan et al. Sci. Rep. 2015, 4, 5639; Gao et al. Nanotechnology, 2012, 23(27), 275605; Liang et al. Angew. Chem. Int. Ed. 2012, 51(46), 11496-500; Yang et al. ACS Nano 2012, 6, 205-211; Wang et al. Chem. Soc. Rev. 2014, 43, 7067-7098; Denis et al. Chem. Phys. Lett. 2010, 492, 251-257; Hassan et al. Nat. Commun. 2015, 6, 8597; Wang et al. Nano Energy 2015, 15, 746-754; Jeon et al. Adv. Mater. 2013, 25, 6138-6145). The doping concentration is varied by precisely controlling the composition of the H₂S+Ar+CH₄ gas mixture. The level of doping can increase with higher H₂S flow rate or increasing H₂S concentrations in Ar carrier gas. S distribution in the graphene lattice can be uniform due to the high degree of uniformity in gas-phase mixing achievable in CVD processes (Kidambi et al. Nano Lett. 2013, 13, 4769-4778; Kidambi et al. ACS Appl. Mater. Interfaces 2018, 10, 10369-10378). S can also be added to the CVD process by subliming S under Ar carrier gas or using Ar carrier gas in a bubbler containing S dissolved in hexane (Gao et al. Nanotechnology, 2012, 23(27), 275605); however, precise control of doping concentration will be challenging in these methods. S-doped graphene monolayers are imaged by STEM to determine the S configurations, which can be both three-fold- and four-fold-coordinated and possibly others. As predicted by theory, discussed earlier, an annealing process is developed to convert three-fold-coordinated to four-fold-coordinated configurations. Pertinent DFT calculations are pursued to interpret the data and guide experiments.

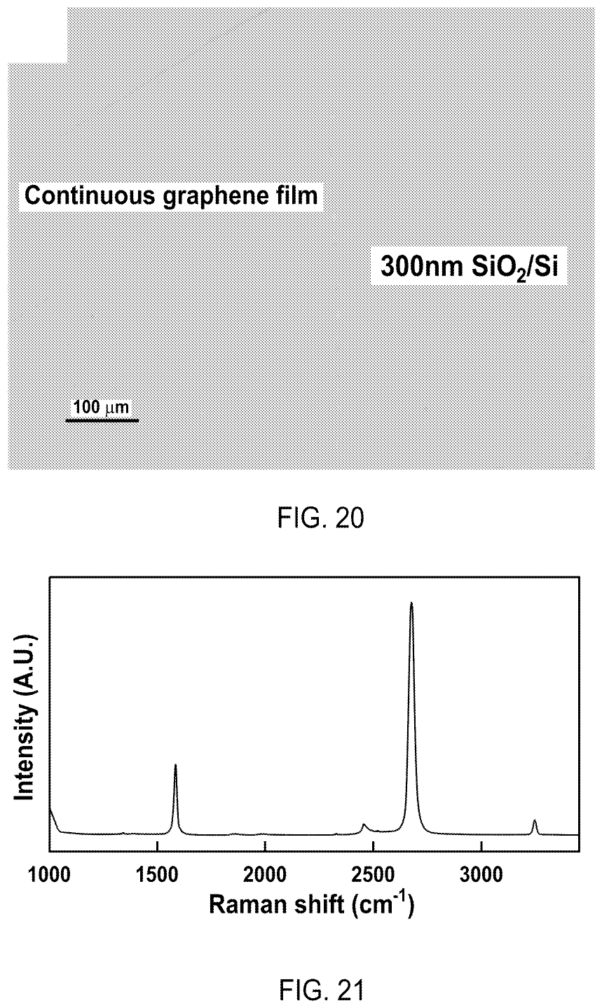

In addition to the synthesis of continuous polycrystalline S-doped graphene films, large, single-crystalline individual S-doped graphene domains which are free of grain boundaries and associated defects are also synthesized to minimize convolution in the proton transport measurements. As controls, high-quality monolayer polycrystalline graphene films (FIG. 19 and FIG. 20) and large single crystalline individual graphene domains (FIG. 18) without S doping are also synthesized (Kidambi et al. ACS Appl. Mater. Interfaces 2018, 10, 10369-10378; Kidambi et al. Adv. Mater. 2018, 1804977; Kidambi et al. Adv. Mater. 2017, 29, 1700277; Kidambi et al. Nanoscale 2017, 9, 8496-8507).

The synthesized materials are characterized using scanning electron microscopy (SEM, FIG. 18 and FIG. 19) and optical microscopy (FIG. 20) for film coverage and uniformity, XPS for evaluating S doping concentration in the graphene, and Raman spectroscopy (FIG. 21) for film quality. Additionally, S dopant distribution in the graphene lattice is characterized using atomic-resolution STEM and STM imaging. Using conditions optimized in prior studies (Kidambi et al. Adv. Mater. 2018, 1804977), STM (e.g., an Omicron UHV STM) is used to image the S-doped graphene directly on the Cu foil. Briefly, the S-doped graphene on Cu is annealed in vacuum at 400 K to remove atmospheric contaminants and/or any absorbents prior to STM imaging. STEM imaging is performed, e.g., using a Nion Ultra at 60 kV (to minimize electron knock-on damage) and medium annular dark field conditions optimized previously for imaging graphene (Kidambi et al. Adv. Mater. 2018, 1804977; Kidambi et al. Adv. Mater. 2017, 29, 1700277). The S-doped graphene is transferred to TEM grids (Au grids, TED Pella) and cleaned thoroughly using procedures developed for achieving atomically clean interfaces for STEM imaging (Kidambi et al. Chem. Mater. 2014, 26, 6380-6392; Kidambi et al. Adv. Mater. 2017, 29, 1700277). Atomic-resolution EELS is used as needed to examine the S configurations (as was done for Si in graphene elsewhere to distinguish between the Si and C atoms (Zhou et al. Phys. Rev. Lett. 2012, 109, 206803)) in the S-doped graphene samples (Kidambi et al. Chem. Mater. 2014, 26, 6380-6392; Kidambi et al. Adv. Mater. 2017, 29, 1700277).

B-doped graphene is synthesized and characterized using methods similar to S-doped graphene. Specifically, carborane (C₂B₁₀H₁₂) diluted in Ar carrier gas is used as the boron dopant precursor (Usachov et al. ACS Nano 2015, 9, 7314-7322; Agnoli et al. J. Mater. Chem. A 2016, 4, 5002-5025). Co-doping of S and B can be achieved by facile gas phase mixing of precursors. Alternatively, B doping or co-doping can be pursued after CVD synthesis of graphene as reported in prior studies (Pan et al. Nano Lett. 2015, 15, 6464-6468).

STM and STEM imaging, combined with DFT calculations, can provide fundamental insights into S dopant incorporation and S—C bonds, distribution and clustering within the graphene lattice with increasing dopant density. Proton transport through the synthesized S-doped graphene with varying dopant concentrations are thoroughly characterized using two different types of devices as described below, seeking to determine the growth conditions and annealing process that give an optimum concentration of the desirable S configuration shown in FIG. 31 and the optimum B-dopant concentration to maximize the proton transport rate without compromising the structural integrity of the graphene lattice and its ability to block transport of larger ions. Hence, the aim is to determine the conditions to achieve the highest selective proton flux across atomically thin graphene membranes S/B co-doping. The use of light illumination (Lozada-Hidalgo et al. Nat. Nanotechnol. 2018, 13, 300-303) to further enhance the transport rate (for applications that allow such conditions) can also be explored.

Liquid phase proton transport is measured across the synthesized S-doped monolayer graphene membranes with varying concentrations of S dopant atoms. Specifically, S-doped monolayer graphene is suspended over an aperture ˜2-10 μm diameter in a Si, SiO₂, or Si₃N₄ wafer or Si₃N₄ TEM grids with a single aperture (Norcada) using a polymer-free transfer method (Kidambi et al. Adv. Mater. 2017, 29, 1605896; Kidambi et al. Adv. Mater. 2017, 29, 1700277; Kidambi et al. Nanoscale 2017, 9, 8496-8507), which effectively minimizes contamination of the atomically thin graphene surface.

The polymer-free transfer method involves carefully placing a drop of isopropanol on the S-doped graphene on Cu (Kidambi et al. Adv. Mater. 2017, 29, 1605896; Kidambi et al. Adv. Mater. 2017, 29, 1700277; Kidambi et al. Nanoscale 2017, 9, 8496-8507). Next, the target substrate is gently contacted with the S-doped graphene on Cu and the isopropanol is allowed to slowly evaporate (Kidambi et al. Adv. Mater. 2017, 29, 1605896; Kidambi et al. Adv. Mater. 2017, 29, 1700277; Kidambi et al. Nanoscale 2017, 9, 8496-8507). Evaporation of isopropanol allows for conformal contact between the target substrate and the S-doped graphene. Finally, the Cu foil is carefully etched away by floating the substrate-graphene-Cu stack on 0.2 M ammonium persulfate solution (Kidambi et al. Adv. Mater. 2017, 29, 1605896; Kidambi et al. Adv. Mater. 2017, 29, 1700277; Kidambi et al. Nanoscale 2017, 9, 8496-8507).

The S-doped graphene membranes suspended on the substrate are washed in DI water and graphene edges on the wafer/TEM grid are sealed with epoxy to prevent leakage at the interface (inset in FIG. 7) (Hu et al. Nature 2014, 516, 227-230). The S-doped graphene membranes are mounted between side-by-side diffusion cells (inset in FIG. 7 and FIG. 22) which are filled with 0.1 M HCl solution (Hu et al. Nature 2014, 516, 227-230). Next, Ag/AgCl electrodes are placed into the HCl solution in both diffusion cells, i.e. on either sides of the graphene membrane, to measure ionic current as function of applied bias.

In addition to proton transport, the structural integrity of the S-doped graphene membranes are tested using our well-developed processes to quantify leakage across sub-nanometer pores in graphene (FIG. 23) (Kidambi et al. Adv. Mater. 2017, 29, 1605896; Kidambi et al. Adv. Mater. 2017, 29, 1700277; Kidambi et al. Nanoscale 2017, 9, 8496-8507). Specifically, diffusion of KCl (K⁺, Cl⁻ hydrated diameter ˜0.66 nm) across the S-doped graphene membranes is probed by filling one side of the diffusion cell with 0.5 M KCl solution while monitoring the conductivity of the other side filled with de-ionized water with the help of a conductivity probe (Kidambi et al. Adv. Mater. 2017, 29, 1605896; Kidambi et al. Adv. Mater. 2017, 29, 1700277; Kidambi et al. Nanoscale 2017, 9, 8496-8507; Kafiah et al. Desalination 2016, 388, 29-37). The increase in conductivity over time is a direct measure of intrinsic sub-nanometer defects (K⁺ and Cl⁻ hydrated ion size ˜0.66 nm) in the suspended S-doped graphene membrane (Kidambi et al. Adv. Mater. 2017, 29, 1605896; Kidambi et al. Adv. Mater. 2017, 29, 1700277; Kidambi et al. Nanoscale 2017, 9, 8496-8507; Kafiah et al. Desalination 2016, 388, 29-37). These control experiments ensure the measured proton transport is not via non-selective leakage through sub-nanometer defects >0.66 nm (Kidambi et al. Adv. Mater. 2018, 1804977; Kidambi et al. Adv. Mater. 2017, 29, 1605896; Kidambi et al. Adv. Mater. 2017, 29, 1700277; Kidambi et al. Nanoscale 2017, 9, 8496-8507; Kafiah et al. Desalination 2016, 388, 29-37). As additional controls, large-area, single-crystalline S-doped graphene domains free of grain boundaries and associated defects are also measured. Finally, undoped graphene polycrystalline films (FIG. 19) and undoped single-crystalline graphene domains (FIG. 18) are also measured for an effective and thorough comparison. The liquid phase proton transport measurements allows for a direct measure of the areal conductivity of protons greatly minimizing convolution from surface contamination and/or other effects that that could potentially arise while interfacing S-doped graphene into a device.

Nafion-graphene-Nafion sandwich devices are used to measure proton transport through S-doped graphene over large areas ˜2 cm×2 cm. To fabricate these devices, ˜2 cm×2 cm Nafion layer (25 μm thick—Nafion 211 or 50 μm thick—Nafion 212) is initially hot-pressed at 140° C. on to ˜2 cm×2 cm S-doped monolayer polycrystalline graphene films on Cu (Hu et al. Nature 2014, 516, 227-230; Bukola et al. J. Am. Chem. Soc. 2018, 140, jacs.7b10853). Next, the Cu foil is etched in 0.2 M ammonium persulfate solution to allow for S-doped graphene transfer to Nafion (Hu et al. Nature 2014, 516, 227-230; Bukola et al. J. Am. Chem. Soc. 2018, 140, jacs.7b10853). The S-doped graphene-Nafion stack is rinsed with deionized water multiple times and dried under laboratory nitrogen (Hu et al. Nature 2014, 516, 227-230; Bukola et al. J. Am. Chem. Soc. 2018, 140, jacs.7b10853). Raman spectroscopy is used to confirm S-doped graphene transfer to Nafion, before hot-pressing another layer of Nafion (with identical properties to the 1^{st} layer underneath S-doped graphene) to form a Nafion-S-doped graphene-Nafion sandwich (schematics in FIG. 4) (Hu et al. Nature 2014, 516, 227-230; Bukola et al. J. Am. Chem. Soc. 2018, 140, jacs.7b10853). Finally, carbon cloth electrodes coated with 4 mg/cm² of Pt black are added to the Nafion layer on either side of the sandwich device to from a polyelectrolyte membrane (PEM)-style hydrogen pump cell (Bukola et al. J. Am. Chem. Soc. 2018, 140, jacs.7b10853).

The PEM cell is mounted in a custom-built test rig and current-voltage curves are acquired using a potentiostat while exposing the PEM cell to humidified hydrogen (Bukola et al. J. Am. Chem. Soc. 2018, 140, jacs.7b10853). The humidity keeps the Nafion in the hydrated state in which it conducts protons (Bukola et al. J. Am. Chem. Soc. 2018, 140, jacs.7b10853). Current-voltage curves are collected in linear sweep or cyclic voltammetry setting and the temperature is systematically varied from 25-80° C. to obtain Arrhenius plots that can be used to compute the activation energy for proton transport (FIG. 6) with varying concentrations of S/B-doping (Bukola et al. J. Am. Chem. Soc. 2018, 140, jacs.7b10853; Bukola et al. Electrochim. Acta 2019, 296, 1-7). Preliminary results with monolayer undoped graphene (FIG. 24-FIG. 27) indicate the feasibility of the approach towards fabricating and testing PEM cells (Bukola et al. J. Am. Chem. Soc. 2018, 140, jacs.7b10853; Bukola et al. Electrochim. Acta 2019, 296, 1-7).

As controls, K⁺ ion transport through the PEM cells is probed to quantify any leakage through areas without graphene or leakage via defects in graphene (Bukola et al. J. Am. Chem. Soc. 2018, 140, jacs.7b10853; Bukola et al. Electrochim. Acta 2019, 296, 1-7). Here, porous filter papers wetted with KCl are sandwiched between modified Nafion (by dipping in K⁺ solution to exchange the functional group on the polymer chains in Nafion) and Ag/AgCl electrodes are used to measure current density vs voltage characteristics for the PEM cells (Bukola et al. J. Am. Chem. Soc. 2018, 140, jacs.7b10853; Bukola et al. Electrochim. Acta 2019, 296, 1-7). Devices without graphene will serve as controls for all of the experiments. Finally, PEM cells ˜100 μm×100 μm single crystalline monolayer S-doped graphene domains (FIG. 18) free of grain boundaries and associated defects are fabricated and tested to facilitate an effective comparison with the liquid phase proton transport studies.

The insights from the S-doped graphene synthesis and extensive hydrogen/proton transport characterization (especially the at % S doping that allows for maximum selective hydrogen/proton transport through the S-doped graphene) can be used to develop scalable roll-to-roll process for manufacturing atomically thin, high-flux proton-exchange membranes (Kidambi et al. ACS Appl. Mater. Interfaces 2018, 10, 10369-10378) for fuel cells (Holmes et al. Adv. Energy Mater. 2017, 7, 1-7), hydrogen purification (Lozada-Hidalgo et al. Nat. Nanotechnol. 2018, 13, 300-303), isotope separation and environmental remediation (Hu et al. Nature 2014, 516, 227-230; Lozada-Hidalgo et al. Science (80-.). 2016, 351, 68-70; Bukola et al. J. Am. Chem. Soc. 2018, 140, jacs.7b10853).

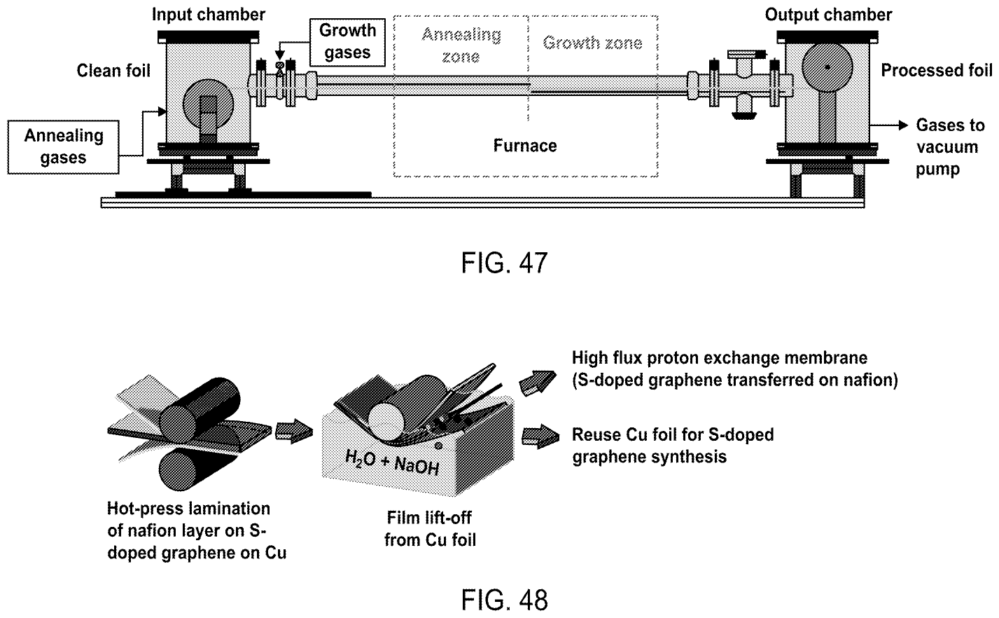

The insights obtained from the DFT calculations, S-doping studies, and proton transport measurements can be used to develop scalable advanced manufacturing processes for atomically thin high flux, proton exchange membranes. The synthesis of 2D materials has largely focused on electronic applications, but membranes applications typically require 1-2 orders of magnitude larger areas (Kidambi et al. ACS Appl. Mater. Interfaces 2018, 10, 10369-10378). The first manufacturing compatible roll-to-roll CVD graphene and facile polymer support casting processes was developed for large-area nanoporous atomically thin membranes for dialysis applications (FIG. 47) (Kidambi et al. ACS Appl. Mater. Interfaces 2018, 10, 10369-10378).

Here, the aim is to build on these advances and develop a roll-to-roll advanced manufacturing prototype reactor (Kidambi et al. ACS Appl. Mater. Interfaces 2018, 10, 10369-10378) (FIG. 47-FIG. 48) that allows for i) in-situ S doping of graphene during roll-to-roll CVD and ii) subsequent roll-to-roll hot-press lamination (˜140° C.) of the synthesized S-doped graphene with Nafion 211 or Nafion 212 polymer supports.

Specifically, a concentric dual quartz tube reactor housed between an input and an output chamber (FIG. 47) is designed and built (Kidambi et al. ACS Appl. Mater. Interfaces 2018, 10, 10369-10378). A roll of pre-cleaned Cu foil (acid dip/sonication followed by rinsing in deionized water and blow dried with nitrogen) is initially loaded into the input chamber and annealed at 1000° C. in H₂ as it passes on a quartz flat (resting along the cylindrical centerline axis of the concentric tubes) through the annealing zone (inner concentric tube 3″ diameter and 3′ length) and exits into the growth zone (outer tube 4″ diameter and 6′ length) where it encounters the CH₄+H₂S+Ar mixture flowing in the annular gap between the inner and outer tube for S-doped graphene synthesis, before proceeding towards the output chamber (Kidambi et al. ACS Appl. Mater. Interfaces 2018, 10, 10369-10378). A split tube furnace (Thermcraft) with a total heated zone length (annealing+growth zone) ˜4′ is used to encase the concentric tubes (FIG. 47). This design allows for annealing of the Cu foil and ensures the growth gases only contact at 1000° C., ensuring high quality S-doped graphene synthesis comparable to samples obtained elsewhere (Kidambi et al. ACS Appl. Mater. Interfaces 2018, 10, 10369-10378). The precise concentration of H₂S is selected based on results obtained above to achieve maximum selective proton flux through the S-doped graphene membranes. The reactor design has minimal moving parts to ensure ease of operation and maintenance (Kidambi et al. ACS Appl. Mater. Interfaces 2018, 10, 10369-10378).

Further, a set of in-line rollers allows for hot-press lamination (Hempel et al. Nanoscale 2018, 10, 5522-5531) (FIG. 48) of Nafion 211 or 212 on the synthesized S-doped graphene before winding the Nafion/S-doped graphene stack on to the roll in the output chamber. The incorporation of an in-line lamination process represents a major technological advance that resolves persistent challenges associated with all roll-to-roll designs to date (Polsen et al. Sci. Rep. 2015, 5, 10257; Kobayashi et al. Appl. Phys. Lett. 2013, 102, 023112), including the state-of-the-art roll-to-roll CVD reactor design (FIG. 47) (Kidambi et al. ACS Appl. Mater. Interfaces 2018, 10, 10369-10378); wherein contact between the back-side of the already wound Cu foil and the front-side of the Cu foil that is being wound causes significant damage to the synthesized high quality monolayer graphene (Kidambi et al. ACS Appl. Mater. Interfaces 2018, 10, 10369-10378).

Post-S-doped graphene growth on the entire roll of Cu foil, the laminate stack of S-doped graphene/Nafion is dipped in 1 M NaOH solution at 60-80° C. to allow for delamination of the Nafion/graphene stack from the Cu surface (Hempel et al. Nanoscale 2018, 10, 5522-5531) due to local Cu surface oxidation (Wang et al. ACS Appl. Mater. Interfaces 2016, 8, 33072-33082). The S-doped graphene on Nafion support layer can then be used as an atomically thin high-flux proton exchange membrane for fuel cells (Holmes et al. Adv. Energy Mater. 2017, 7, 1-7), H purification (Lozada-Hidalgo et al. Nat. Nanotechnol. 2018, 13, 300-303), isotope separation (Hu et al. Nature 2014, 516, 227-230; Lozada-Hidalgo et al. Science (80-.). 2016, 351, 68-70; Bukola et al. J. Am. Chem. Soc. 2018, 140, jacs.7b10853), environmental remediation (Hu et al. Nature 2014, 516, 227-230; Lozada-Hidalgo et al. Science (80-.). 2016, 351, 68-70; Bukola et al. J. Am. Chem. Soc. 2018, 140, jacs.7b10853), and membrane electrode applications, while the Cu foil can be re-used for S-doped roll-to-roll graphene synthesis.

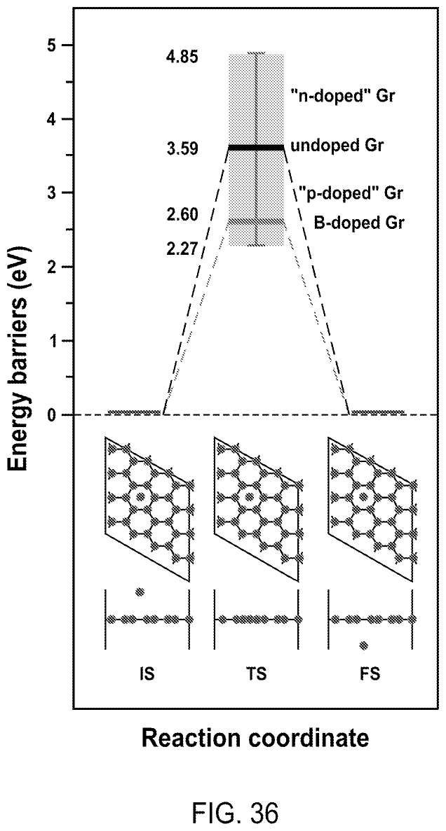

This research can allow for the development of advanced manufacturing approaches for scalable and cost-effective synthesis of atomically thin high flux proton transport membranes. Density functional theory (DFT) provides a computationally cost-effective methodology for the calculation of electronic structure, atomic-scale forces, and the optimization of the atomic structure of materials. Through the use of techniques such as the nudged-elastic band method and ab-initio molecular dynamics, diffusion and atomic migration processes can be studied at the atomic scale in order to understand the factors relevant to manipulation of the energy barriers. Furthermore, DFT can be used to calculate dopant- and impurity-atom formation energies to provide guidance on the feasibility of modifying the graphene lattice. To this end, calculations were performed on the inclusion of sulfur atoms as a dopant species (FIG. 31 and FIG. 32-FIG. 37), as discussed above. These calculations currently neglect the inclusion of explicit blocking of the chemisorption sites and the zero-point energy quantum effects. In future calculations, the effect of chemisorption site blocking can be included by modeling hydrogenation of the four-fold-coordinated S complex. The zero-point energy correction can be applied in a straightforward manner via the calculation of the F-point phonon frequencies of the initial and transition-state geometries 9 Gross et al. J. Vac. Sci. Technol. A Vacuum, Surfaces, Film. 1997, 15, 1624-1629; Henkelman et al. J. Chem. Phys. 2006, 124, 044706).

In pristine and hydrogen-adsorbed graphene, each ring can be assumed to be statistically similar. However, once the S dopant is included distortions of surrounding rings are also present. Therefore, the effect on the migration barrier at six-member carbon rings adjacent to the sulfur-included ring is investigated. Furthermore, more detailed understanding of the role of explicit dopants (such as boron substitution for carbon) in lowering the barrier compared to implicit dopant by changing the Fermi level through removal of an electron is pursued. The goal of these calculations is to provide insight into the relative roles of different effects (doping, distortions of the S-six-member ring, hydrogenation of surring C atoms, etc.) in controlling the energy barrier and hence the H transport rate. Such insights can provide guidance to the experimental work as well as an understanding of how observed improvements arise. Results from STEM imaging can be incorporated into calculations to further improve the overall understanding of the processes and whether they enable the transport of species other than H.

Using DFT calculations, the influence of other dopant atoms into the graphene lattice can be probed. Replacing two C atoms by P also introduces large hexagonal rings like S, but also dopes graphene p-type, whereby the dual objective of larger pores and p-type doping can be accomplished with a single dopant. DFT calculations can be pursued to explore effects that arise from co-doping with S and B. Finally, dopants such as Se or even elements from other parts of the periodic table that may be even more effective than S in generating larger pores for proton transport without compromising selectivity can be explored and followed up with test experiments. DFT results can be compared with experiments to develop a detailed comprehensive understanding of proton transport through S-doped graphene and with increasing dopant concentrations.

Membrane technologies present potential for alleviating global problems in energy that directly impact the lives of billions of people around the world. Disruptive technologies such as atomically thin proton exchange membranes can play a critical role in advancing next-generation fuel cells (Holmes et al. Adv. Energy Mater. 2017, 7, 1-7), hydrogen purification (Lozada-Hidalgo et al. Nat. Nanotechnol. 2018, 13, 300-303), isotope separation (Hu et al. Nature 2014, 516, 227-230; Lozada-Hidalgo et al. Science (80-.). 2016, 351, 68-70; Bukola et al. J. Am. Chem. Soc. 2018, 140, jacs.7b10853), environmental remediation (Hu et al. Nature 2014, 516, 227-230; Lozada-Hidalgo et al. Science (80-.). 2016, 351, 68-70; Bukola et al. J. Am. Chem. Soc. 2018, 140, jacs.7b10853), and other applications. Such advances can contribute to cleaner energy generation and improved efficiency in energy conversion to help address the causes and detrimental effects of climate change. This research can address the following challenges 1) maximize selective proton transport through atomically thin membranes and 2) develop scalable advanced manufacturing processes to synthesize these membranes in a cost-effective manner with reliable and reproducible quality.

The research can provide fundamental theoretical and experimental insights into the deliberate enlargement of the intrinsic pores of graphene via the incorporation of dopant atoms, the distribution and possible clustering of dopants, and the mechanism of proton transport through the membrane. These insights can advance atomically thin proton exchange membranes towards practical applications. The project can elucidate sub-nanometer-scale mass transport using table-top experiments and target major challenges in nanotechnology, i.e., 1) controlled, precise, and uniform incorporation of dopant atoms in a monolayer using facile and scalable processes and 2) optimization of transport of thermal protons by enhancing the size of intrinsic pores in otherwise defect-free atomically thin materials.

### Example 3

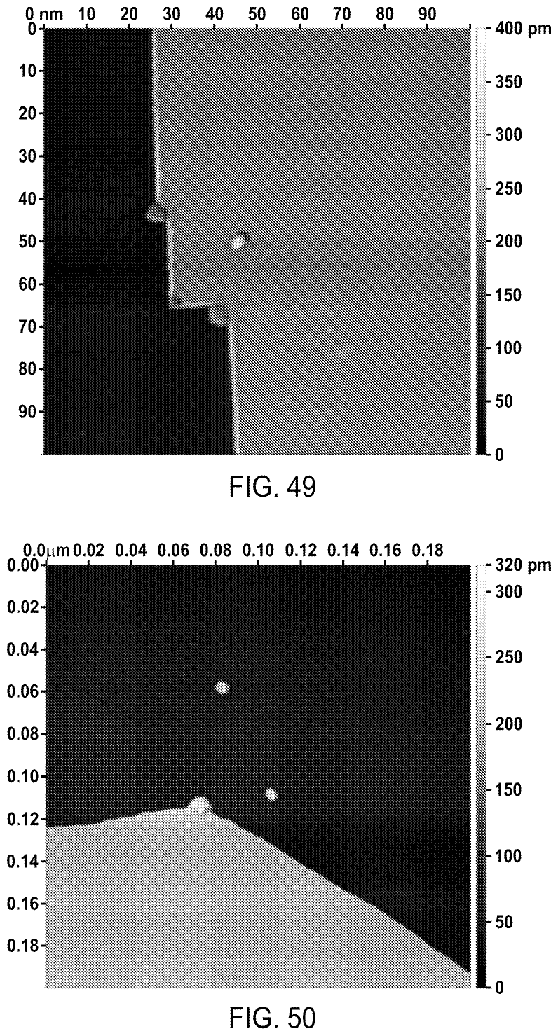

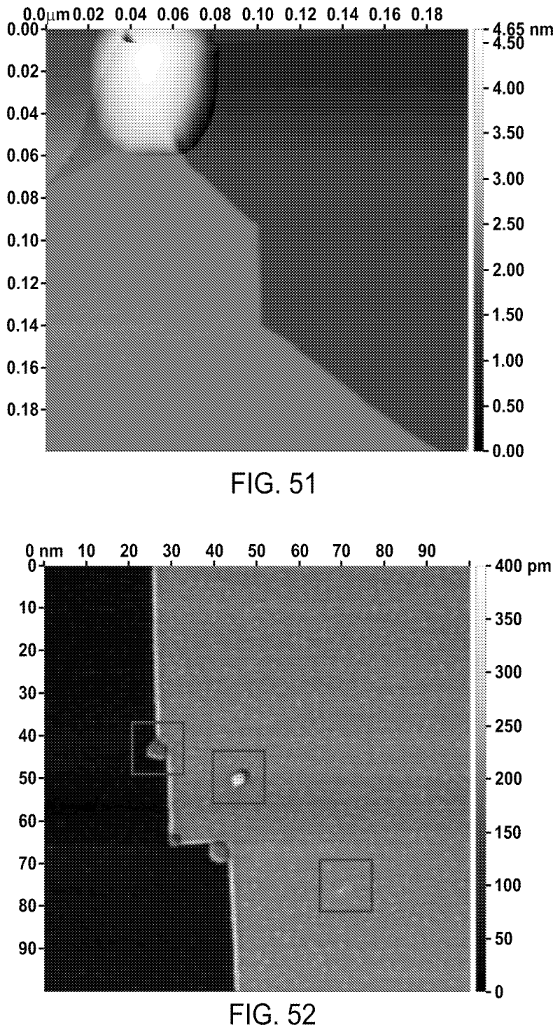

STM images of sulfur-doped graphene show nanobubbles of sulfur under the graphene upon heating (FIG. 49-51). A sample of sulfur-doped graphene was annealed in UHV at 340° C. for 1 hour (FIG. 49). Upon annealing the same sample further in UHV at 420° C. for 1 hour, the surface became much rougher (FIG. 50). Upon further annealing the sample in UHV at 420° C. for 1 hour, large nanobubbles appeared (FIG. 51).

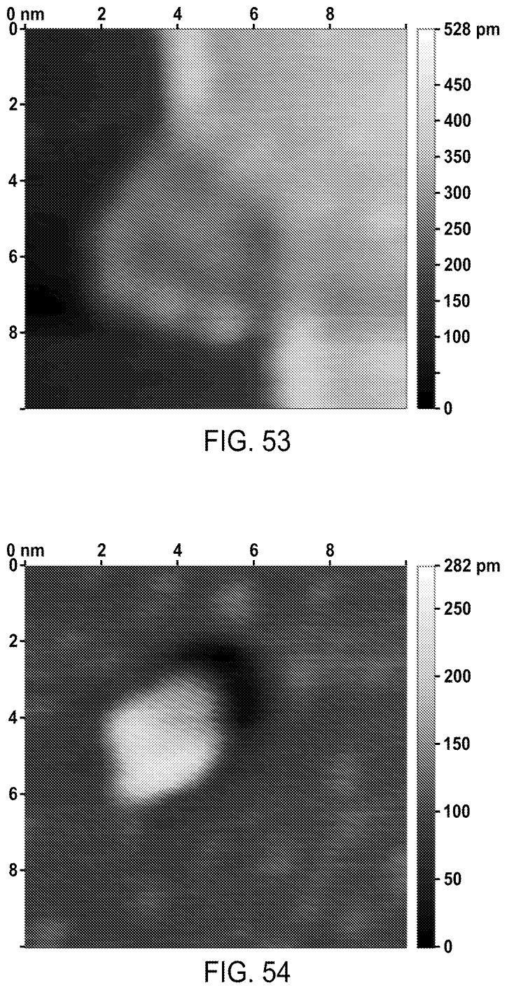

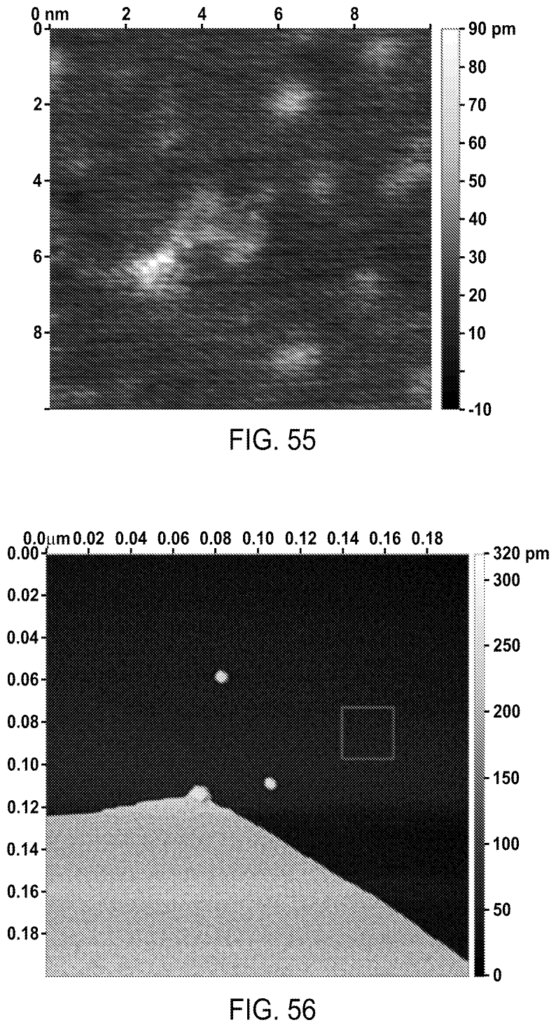

The STM image of sulfur-doped graphene in FIG. 49 shows various bright regions, as indicated in FIG. 52 with boxes. Higher magnification STM images of the left-most and center bright region are shown in FIG. 53 and FIG. 54, respectively. These bright regions are small nanobubbles, which may indicate that S intercalated. A higher magnification STM image of the right-most bright area is shown in FIG. 55. These bright regions likely indicate defects in the graphene lattice (e.g., S dopant) and/or subsurface defects (e.g., indicating S intercalation).

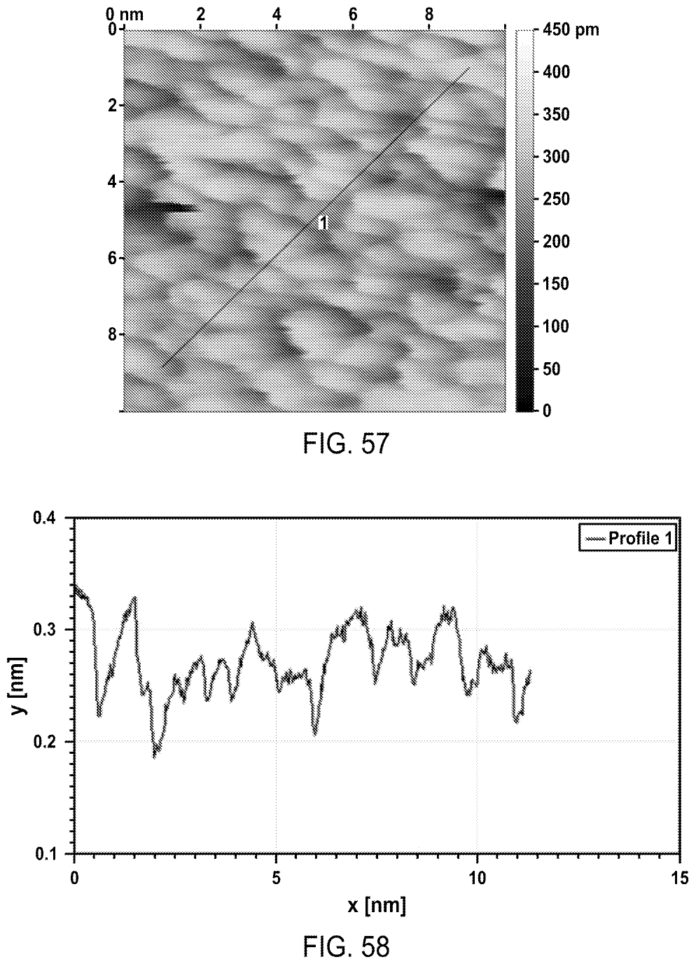

Sulfur doped graphene shows nanoscale blisters of sulfur underneath the graphene in addition to some sulfur incorporated into the lattice (FIG. 56-FIG. 58). The surface of the sulfur doped graphene is very flaky and unstable; therefore the graphene atoms were not able to be imaged (FIG. 56 and FIG. 57). A linecut shows a high corrugation of about 1-1.5 Å. Graphene looks like it is suspended on the trapped gases.

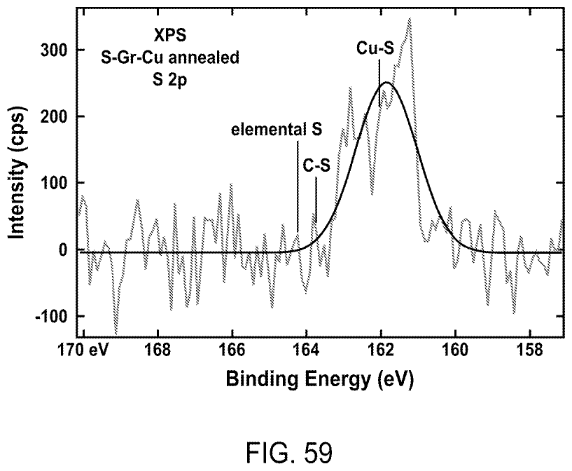

The XPS spectrum of an S-doped graphene sample that had previously been annealed for STM measurements is shown in FIG. 59. A S 2p signal corresponds to 0.09% of the total XPS intensity (FIG. 59). If the signals are determined relative to carbon, then the data indicates an 0 coverage of 27% and S of 0.5±0.1% (FIG. 59).

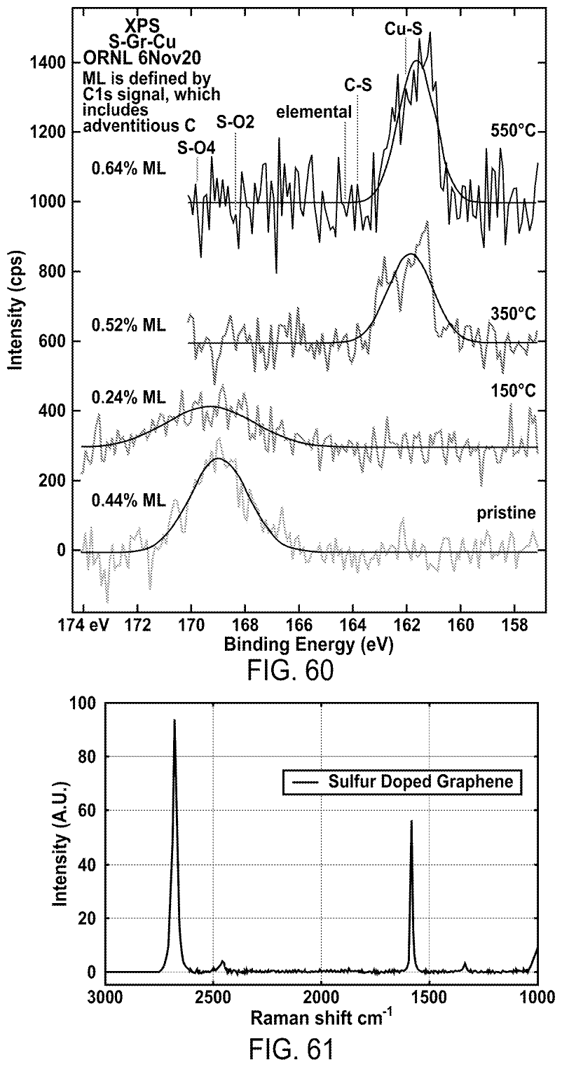

The XPS spectra of S-doped graphene as a function of annealing in vacuum are shown in FIG. 60. As can be seen in FIG. 60, the S goes from oxide to being inside the Cu. This indicates the S was initially at the interface between graphene and Cu, e.g. that it was precipitating from the Cu bulk and was initially dissolved into the Cu during exposure via CVD at temperature. The annealing not only removed the adventitious carbon from the graphene surface but also causes the S at the interface to reduce and then dissolve into the Cu bulk (FIG. 60). This is consistent with the nanoscale blisters seen with STM. Further, the peak in the 350° C. spectrum in FIG. 60 indicates C—S bonding consistent with the STM image in FIG. 55.

FIG. 61 is a Raman spectrum of S doped graphene, showing an increase in the D peak which indicates defects in the lattice.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The methods of the appended claims are not limited in scope by the specific methods described herein, which are intended as illustrations of a few aspects of the claims and any methods that are functionally equivalent are intended to fall within the scope of the claims. Various modifications of the methods in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

1. A proton transport membrane comprising:
a two-dimensional (2D) material having a top surface and a bottom surface;
wherein the two-dimensional material comprises hexagonal boron nitride, graphene, or a combination thereof; and
wherein:
the top surface is functionalized with a first functional moiety and the bottom surface is not functionalized;
the top surface is functionalized with a first functional moiety and the bottom surface is functionalized with the first functional moiety; or
the top surface is functionalized with a first functional moiety and the bottom surface is functionalized with a second functional moiety, the second functional moiety being different than the first functional moiety.

2. The proton transport membrane of claim 1, wherein:
the top surface is functionalized with the first functional moiety and the bottom surface is not functionalized; or
the top surface and the bottom surface are functionalized with the first functional moiety.

3. (canceled)

4. The proton transport membrane of claim 2, wherein the first functional moiety is selected from the group consisting of hydrogen, halogen, and combinations thereof.

5-9. (canceled)

10. The proton transport membrane of claim 1, wherein the top surface is functionalized with the first functional moiety and the bottom surface is functionalized with the second functional moiety, the second functional moiety being different than the first functional moiety.

11. The proton transport membrane of claim 10, wherein the two-dimensional material comprises graphene such that the membrane comprises Janus graphene.

12. The proton transport membrane of claim 10, wherein the first functional moiety and the second functional moiety are selected from the group consisting of H, F, Cl, Br, I, and combinations thereof.

13-15. (canceled)

16. The proton transport membrane of claim 10, wherein the first functional moiety comprises H and the second functional moiety comprises F or Cl.

17. (canceled)

18. The proton transport membrane of claim 1, wherein the two-dimensional material comprises graphene and the first functional moiety, the second functional moiety when present), or a combination thereof comprise(s) H, F, Cl, or a combination thereof.

19. The proton transport membrane of claim 1, wherein the two-dimensional material is doped with a substitutional dopant in an amount of from greater than 0 atomic % (at %) to less than 100 at %.

20. A proton transport membrane comprising:
a two-dimensional (2D) material having a top surface and a bottom surface;
wherein the two-dimensional material comprises hexagonal boron nitride, graphene, or a combination thereof;
wherein the two-dimensional material is doped with a substitutional dopant in an amount of from greater than 0 atomic % (at %) to less than 100 at %.

21. The proton transport membrane of claim 20, wherein the two-dimensional material is doped with a substitutional dopant in an amount of from greater than 0% to 9 at %.

22. The proton transport membrane of claim 20, wherein the substitutional dopant comprises a group I-VII element atom, a period I-VII, or a combination thereof.

23-26. (canceled)

27. The proton transport membrane of claim 19, wherein:
the two-dimensional material comprises graphene and the substitutional dopant comprises B, N, P, S, or a combination thereof;
the two-dimensional material comprises h-BN and the substitutional dopant comprises C;
or a combination thereof.

28. (canceled)

29. (canceled)

30. The proton transport membrane of claim 19, wherein the two-dimensional material comprises graphene and hexagonal-boron nitride in an atomic ratio of from 99:1 to 1:99.

31. A proton transport membrane comprising:
a two-dimensional (2D) material having a top surface and a bottom surface;
wherein the two-dimensional material comprises graphene and hexagonal-boron nitride in an atomic ratio of from 99:1 to 1:99.

32. The proton transport membrane of claim 31, wherein the two-dimensional material comprises graphene and hexagonal-boron nitride in an atomic ratio of from 60:40 to 40:60.

33-35. (canceled)

36. The proton transport membrane of claim 1, further comprising a first proton conducting polymer deposited on the top surface and/or the bottom surface of the two-dimensional material.

37. (canceled)

38. The proton transport membrane of claim 36, further comprising a second proton conducting polymer, the second proton conducting polymer being different than the first proton conducting polymer, and wherein the first proton conducting polymer is deposited on the top surface and the second proton conducting polymer is deposited on the bottom surface.

39. (canceled)

40. The proton transport membrane of claim 38, wherein the first proton conducting polymer, the second proton conducting polymer, or a combination thereof comprise(s) a polyether, a polysulfonate, a polysulfone, a poly(imidazole), a triazole, a benzimidazole, a polyester, a polycarbonate, a polymer derived from a pyridine monomer, a polyethylene, a fluoropolymer, derivatives thereof, or combinations thereof.

41-43. (canceled)

44. The proton transport membrane of claim 38, wherein the first proton conducting polymer, the second proton conducting polymer, or a combination thereof comprise(s) a copolymer of tetrafluoroethylene and perfluoro-3,6-dioxa-4-methyl-7-octene-sulfonic acid (Nafion), poly(tetrafluoroethylene-co-2,2,4-trifluoro-5-trifluoromethoxy-1,3-dioxole) (Hyflon), derivatives thereof, or combinations thereof.

45-57. (canceled)
